(19) United States
(12) Patent Application Publication
(10) Pub. No.: US 2026/0289178 A1
(43) Pub. Date: Sep. 24, 2026

(54) SYSTEM

(71) Applicant: SoftBank Group Corp., Tokyo (JP)

(72) Inventor: Fumie KATO, Tokyo (JP)

(73) Assignee: SoftBank Group Corp., Tokyo (JP)

(21) Appl. No.: 19/567,035

(22) Filed: Mar. 14, 2026

(30) Foreign Application Priority Data
Mar. 19, 2025 (JP) 2025-045131

(51) Int. Cl. G06F 40/40; G06N 3/045; G06N 3/0464; G06N 3/0475; G06V 10/82; G06V 30/148; G06V 30/413

(52) U.S. Cl. CPC G06F 40/40; G06N 3/045; G06N 3/0464; G06N 3/0475; G06V 10/82; G06V 30/15; G06V 30/413

(57) ABSTRACT

A system includes a processor that is configured to analyze a product image provided by a user to extract identification information and features of a product shown in the product image, compare the extracted identification information with document information related to products of each manufacturer to identify a target product, and generate a prompt for instructing a generative artificial intelligence model to generate an answer to a question regarding the identified product, and automatically generate the answer based on the prompt by using natural language processing techniques.

### CROSS-REFERENCE TO RELATED APPLICATION

This application is based on and claims priority under 35 USC 119 from Japanese Patent Application No. 2025-045131 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional technical support systems relying on static manuals, simple keyword search, or rule-based chatbots are often unable to provide accurate, context-aware, and emotionally appropriate answers to user questions about products. In particular, when a user provides only a product image without clearly specifying a model number, conventional systems have difficulty reliably identifying the product and retrieving relevant documentation. Furthermore, even when generative artificial intelligence models are employed to create answers from documentation, such systems typically do not adapt answer content and format to the user's emotional state, for example frustration or confusion detected from the user's tone, facial expression, or wording. In addition, conventional systems generally lack mechanisms to evaluate the reliability of automatically generated answers and to timely involve human operators when the reliability is insufficient. As a result, the user may receive inaccurate or inappropriate answers, leading to reduced user satisfaction and potential misuse or incorrect operation of the product.

### SUMMARY

To solve the above problems, according to one aspect of the present invention, there is provided a system comprising a processor, wherein the processor is configured to analyze a product image provided by a user to extract identification information and features of a product shown in the product image, compare the extracted identification information with document information related to products of each manufacturer to identify a target product, and generate a prompt for instructing a generative artificial intelligence model to generate an answer to a question regarding the identified product, and automatically generate the answer based on the prompt by using natural language processing techniques. The processor is further configured to evaluate an emotional state of the user by analyzing at least one of a voice tone of the user, a facial expression of the user, and wording of text provided by the user, and to adjust at least one of content and format of the answer based on the emotional state, thereby improving the appropriateness and user-friendliness of the response. Moreover, the processor is configured to evaluate a reliability of the generated answer and, in a case where the reliability is below a predetermined threshold, to cause a human operator to intervene to supplement or modify the answer, thereby ensuring that the user ultimately receives a reliable and accurate response even when automatic generation alone is insufficient.

The term “processor” refers to any hardware and/or software based information processing unit, including but not limited to a CPU, GPU, microcontroller, ASIC, FPGA, or a combination of such elements, that executes instructions to perform the functions described in the present specification.

The term “product image” refers to digital image data representing at least a part of a physical product, captured for example by a camera of a user terminal, and including visual information suitable for identifying the product and/or its features.

The term “identification information” refers to information that uniquely or quasi-uniquely distinguishes a product from other products, including but not limited to a model number, product name, serial number, brand name, logo, or other identifiers obtained from the product image or related sources.

The term “features of a product” refers to visual or descriptive attributes associated with a product, including but not limited to shape, color, layout of controls, icons, labels, markings, and externally visible structural characteristics, as well as metadata derived therefrom.

The term “document information” refers to electronic data representing information related to products, including but not limited to user manuals, operation guides, specification sheets, troubleshooting guides, frequently asked questions (FAQs), technical bulletins, and other manufacturer-provided or system-stored documents.

The term “target product” refers to a specific product identified by the system as corresponding to the product image or user input, based on comparison of extracted identification information and document information.

The term “generative artificial intelligence model” refers to a machine learning model, such as a large language model, sequence-to-sequence model, or other generative model, that is capable of generating natural language text or other content in response to an input prompt.

The term “prompt” refers to data, typically in the form of structured or unstructured text, that specifies instructions, context, and/or constraints provided to a generative artificial intelligence model to cause the model to generate an answer to a user's question.

The term “natural language processing techniques” refers to computational methods for processing human language, including but not limited to parsing, semantic analysis, intent detection, text generation, summarization, and dialogue management, used to automatically generate or refine answers.

The term “emotional state” refers to a psychological or affective condition of the user, such as calmness, frustration, confusion, satisfaction, or urgency, inferred by the system from one or more types of user input.

The term “voice tone” refers to acoustic characteristics of the user's speech, including but not limited to pitch, volume, speed, intonation, and prosody, that can be used to infer the user's emotional state.

The term “facial expression” refers to visual information obtained from an image or video of the user's face, including positions and movements of facial muscles and features, that can be analyzed to infer the user's emotional state.

The term “wording of text” refers to linguistic characteristics of text input provided by the user, including choice of words, sentence structure, punctuation, use of polite or impolite expressions, and other stylistic features relevant to emotional analysis.

The term “content of the answer” refers to the substantive information included in the answer provided to the user, such as instructions, explanations, warnings, recommendations, and references to documentation.

The term “format of the answer” refers to the manner or style in which the answer is presented to the user, including but not limited to length, level of detail, politeness level, use of step-by-step instructions, inclusion of summaries, and selection of modality such as text or audio.

The term “reliability of the generated answer” refers to an evaluation value indicating the degree of correctness, appropriateness, and completeness of an automatically generated answer, which may be represented by a numerical score, confidence value, or classification.

The term “predetermined threshold” refers to a reference value set in advance, such as a numerical confidence level, used to determine whether the reliability of the generated answer is sufficient or whether intervention by a human operator is required.

The term “human operator” refers to a human support staff member, agent, or specialist who reviews automatically generated answers, provides supplemental or corrective information, and generates or approves final answers to be delivered to the user.

The term “intervene” refers to an action in which the human operator participates in the answer generation process, including but not limited to reviewing, supplementing, correcting, or replacing an automatically generated answer before it is provided to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

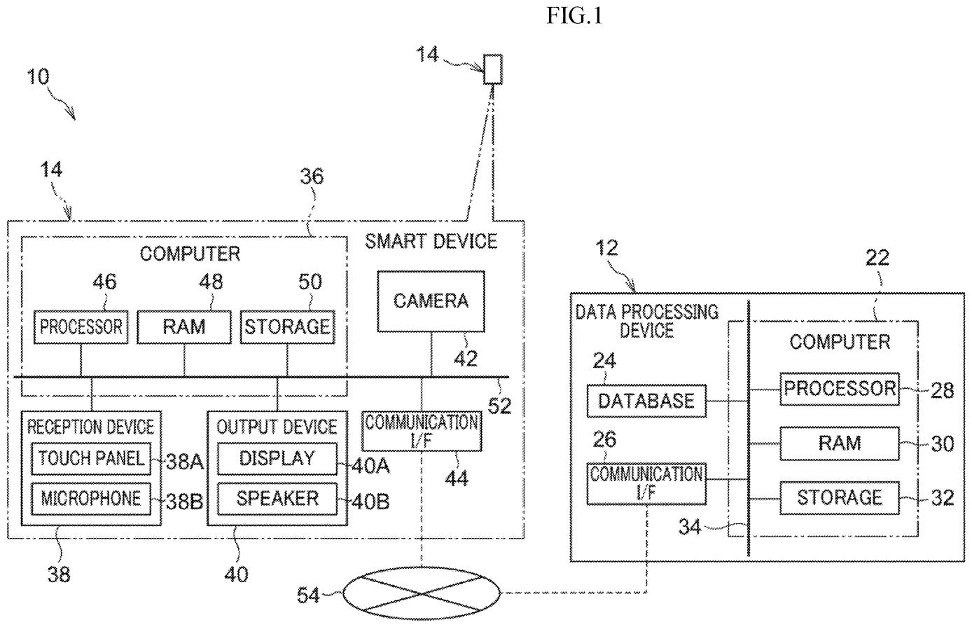

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

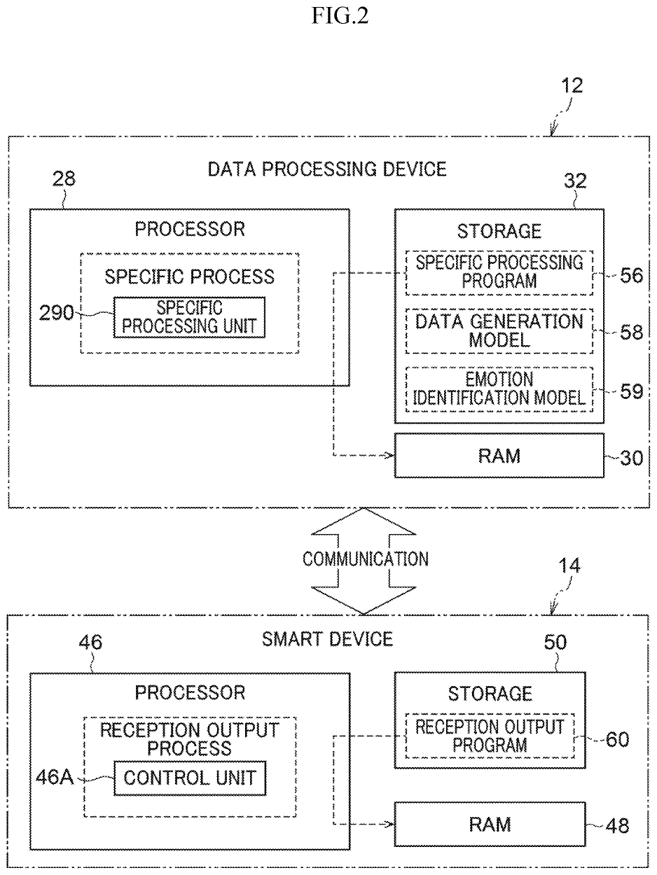

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional question answering systems for consumer products typically rely on manual selection of a product model from a list or on simple keyword matching against pre-stored text. Such systems have several technical limitations. First, they often lack robust mechanisms to automatically and accurately identify a product from image data acquired by a user terminal. As a result, server-side processing must either handle ambiguous identifiers or depend on user input, which increases latency, processing overhead, and error rates in downstream retrieval and answer generation. Second, even when a product is correctly identified, conventional systems usually pass large, unfiltered document sets to a natural language processing module or generative model, causing inefficient use of computational resources, increased network traffic, and higher end-to-end response time. Third, existing architectures typically treat a generative AI model as a black box text generator without systematically structuring prompt sentences based on product-specific document information and user inquiry context, which leads to unstable answer quality and difficulty in controlling the behavior of the model. Fourth, most systems lack mechanisms to adapt the generation and presentation of answers to a user's emotional state or to route low-reliability outputs to human operators, resulting in sub-optimal user interaction and requiring additional manual support outside the system.

Accordingly, there is a need for a technical architecture that integrates image analysis, database retrieval, and generative AI-based response generation in a unified server-side workflow, in which product identification information is normalized and matched to structured document data, and in which a prompt sentence is programmatically constructed to constrain and guide a generative AI model. There is also a need to perform server-side evaluation of generated answer reliability and user emotional state, so that the server can algorithmically adjust prompt style and response formatting, and selectively invoke human intervention only when necessary. By improving these components at the server level, it becomes possible to reduce processing load, improve throughput, enhance answer consistency, and provide a more efficient and reliable computer-implemented question answering service for product support.

The specific processing by the specific processing unit 290 of the data processing device 12 in Example 1 is realized by the following means.

The present invention provides a server comprising a processor configured to acquire, from a user terminal via a communication network, image data including a product, execute image analysis processing using image processing software and machine learning software to extract character information and pattern information from the image data and obtain identification information and feature information of the product, normalize and integrate product identification information based on the identification information and the feature information, retrieve document information associated with a target product by performing a matching process between the product identification information and product information stored in an information storage apparatus using a query language, extract, from the document information, information related to a natural language inquiry from a user, generate a prompt sentence for a generative AI model by constructing a prompt including the related information and the inquiry, transmit the prompt to the generative AI model, obtain answer text regarding the target product from the generative AI model, perform predetermined formatting processing and content verification processing on the obtained answer text to generate response data for presentation to the user, and transmit the response data to the user terminal as text data and, when necessary, convert the response data into audio data using speech synthesis software and transmit the audio data to the user terminal, and further configured, in certain embodiments, to estimate an emotional state of the user based on audio data, image data, and text data acquired from the user terminal to adjust a description style of the prompt and an expression style of the response data, and to evaluate reliability of the answer text and, when the reliability is less than a predetermined threshold, present the prompt and the answer text to a human response support apparatus and reflect supplementary information or correction information from the human response support apparatus in the response data. This enables a computer-implemented support system in which server-side components more efficiently and accurately identify products from user-provided images, retrieve only relevant product documents, construct structured and context-aware prompt sentences to guide a generative AI model, algorithmically control and validate generated answers based on user state and reliability metrics, and thereby improve processing efficiency, response time, and answer quality in comparison with conventional systems.

The term “user terminal” refers to an information processing apparatus operated by a user, including but not limited to a mobile communication device, a tablet device, a personal computer, or any other computing device capable of capturing data, displaying information, and transmitting and receiving data via a communication network.

The term “communication network” refers to a wired or wireless data transmission infrastructure, including but not limited to the Internet, a local area network, a wide area network, a cellular network, or any combination thereof, through which the user terminal and the server exchange data.

The term “image data” refers to digital data representing a still image or a sequence of images, in any format such as a bitmap format or a compressed format, that includes at least part of a product or its label.

The term “product” refers to any physical article, apparatus, device, or equipment for which information, documentation, or support is provided by the system.

The term “image processing software” refers to a software component or library executed by the processor to perform operations on image data, such as decoding, resizing, noise reduction, feature extraction, region detection, and other image analysis operations.

The term “machine learning software” refers to a software component or library executed by the processor that implements a trained statistical model, neural network, or other learning algorithm for tasks including, but not limited to, classification, detection, recognition, or prediction.

The term “character information” refers to textual content detected within image data, including alphanumeric characters, symbols, and codes, such as product model numbers, serial numbers, manufacturer names, and other text.

The term “pattern information” refers to non-textual visual features detected within image data, including shapes, logos, color patterns, structural patterns, or other graphical elements associated with a product.

The term “identification information” refers to information derived from character information, pattern information, or both, that uniquely or semi-uniquely indicates a particular product or a product series.

The term “feature information” refers to descriptive attributes of a product, including but not limited to functional type, category, appearance characteristics, or other metadata obtained through image analysis or associated data processing.

The term “product identification information” refers to a standardized representation of one or more pieces of identification information and feature information, used by the processor to perform matching against stored product information.

The term “normalize” refers to a process of transforming data into a canonical or standardized form, including operations such as removing extraneous characters, unifying character case, converting formats, or resolving variations of product codes to a consistent representation.

The term “integrate” refers to a process of combining multiple pieces of information, including multiple identification candidates or features, into a unified product identification information used for subsequent retrieval.

The term “information storage apparatus” refers to any hardware and software combination that stores product information and document information, including a database system, a file storage system, or a memory device accessible by the processor.

The term “product information” refers to structured or unstructured data associated with products, including identifiers, specifications, categories, and relationships that are stored in the information storage apparatus.

The term “document information” refers to textual or multimedia content associated with a product, including but not limited to manuals, usage instructions, technical specifications, safety warnings, and frequently asked questions.

The term “query language” refers to a formal language used by the processor to specify retrieval conditions to the information storage apparatus, including but not limited to a structured query language or any other database query syntax.

The term “natural language inquiry” refers to a question or request expressed by a user in a human language, in textual, spoken, or transcribed form, relating to the use, function, maintenance, or other aspect of a product.

The term “prompt” refers to an input text or data structure constructed by the processor, including at least part of the document information and the natural language inquiry, and provided to a generative AI model to guide generation of an answer.

The term “prompt sentence” refers to a textual representation of the prompt, typically in the form of one or more sentences or paragraphs, arranged to instruct the generative AI model how to respond.

The term “generative AI model” refers to a machine-implemented model configured to generate natural-language text or other media in response to input data, such as a large language model or other generative model trained on data sets.

The term “answer text” refers to natural-language text generated by the generative AI model in response to the prompt, and describing an answer or explanation regarding the target product.

The term “response data” refers to data generated by the processor for presentation to the user, including at least the answer text and optionally additional metadata, formatting information, or audio data.

The term “formatting processing” refers to operations performed by the processor to modify the structure or appearance of the answer text, such as adding headings, bullet points, line breaks, or other layout features suitable for display.

The term “content verification processing” refers to operations performed by the processor to evaluate and, optionally, adjust the answer text based on predetermined rules, constraints, or checks, such as consistency with product information or inclusion of required safety content.

The term “speech synthesis software” refers to a software component executed by the processor that converts text, including the answer text or response data, into audio data representing synthetic speech.

The term “audio data” refers to digital data representing sound, including synthesized speech, in any encoding format suitable for playback by the user terminal.

The term “emotional state” refers to a classification or estimation of a user's affective condition, such as calmness, frustration, urgency, or satisfaction, inferred from audio data, image data, or text data associated with the user.

The term “description style of the prompt” refers to the linguistic and structural characteristics of the prompt, including tone, level of detail, politeness, and instruction patterns, which can be modified in accordance with the user's emotional state.

The term “expression style of the response data” refers to the manner in which the response data is expressed to the user, including degree of formality, length, level of technical detail, and arrangement of explanations.

The term “reliability” refers to an evaluation metric computed by the processor that indicates the likelihood that the answer text is correct, appropriate, and consistent with the product information and document information.

The term “reliability evaluation processing” refers to processing executed by the processor to calculate or estimate the reliability of the answer text, using rules, statistical models, machine learning models, or heuristic criteria.

The term “predetermined threshold” refers to a reference value, stored or configurable in the system, used to determine whether the evaluated reliability of the answer text is acceptable or requires intervention.

The term “human response support apparatus” refers to an interface or system used by a human operator to review, supplement, or correct the prompt and the answer text, and to provide supplementary information or correction information to the server.

The term “supplementary information” refers to additional explanatory text, clarifications, or details provided by the human response support apparatus to enhance or extend the answer text.

The term “correction information” refers to modifications or replacements of a portion or entirety of the answer text provided by the human response support apparatus to improve accuracy or appropriateness.

The term “target product” refers to a particular product that has been identified or selected by the processor as corresponding to the product included in the image data and associated with the natural language inquiry.

In one embodiment, a server cooperates with one or more terminals operated by users in order to provide product-specific answers generated by a generative AI model. The server is implemented as a computer system including at least one central processing unit (CPU), a random access memory (RAM), a non-volatile storage device such as a solid state drive, and a network interface controller connected to a communication network. The server executes an operating system such as a general-purpose server operating system, and application software including an image analysis module, a database access module, a prompt construction module, a generative AI client module, a reliability evaluation module, and a response formatting module.

The terminal is implemented as a mobile communication device, tablet device, or personal computer including a processor, a display, a camera, a microphone, a speaker, a memory, and a wireless or wired communication interface. The terminal executes an operating system such as a mobile device operating system and an application program that provides a user interface for capturing images of products, for entering or recording user questions, and for displaying or playing back answers received from the server.

The user operates the terminal to capture an image of a product, for example a home appliance such as a microwave oven or an air conditioner. The terminal controls the built-in camera hardware through a camera application programming interface provided by the operating system, and stores the captured image as digital image data in a compressed format such as JPEG or PNG. The terminal then transmits the image data to the server over the communication network using a protocol such as HTTPS.

The server receives the image data through a web application framework and stores the image data in the storage device. The server executes the image analysis module to decode the image into an internal array structure, for example, a three-dimensional array representing pixel intensities. The server uses an image processing library, such as a general image processing library capable of grayscale conversion, binarization, edge detection, and region-of-interest extraction, to enhance regions likely to contain product labels, text, and logos. The server further uses a machine learning library, such as a deep learning framework, to run one or more trained neural networks.

In one embodiment, the server uses a convolutional neural network (CNN) to detect text regions and a separate CNN-based optical character recognition (OCR) network to convert the pixel values in each text region into sequences of characters. The CNN is implemented as multiple convolutional layers with rectified linear unit activations, pooling layers, and fully connected layers trained with a cross-entropy loss function. The server stores trained weight parameters in the storage device and loads them into memory at runtime. The server applies the OCR network to each detected region to obtain character information such as model numbers (“XYZ123”), serial codes, and manufacturer codes.

The server also uses another CNN or a hybrid network combining convolutional layers and fully connected layers to recognize pattern information, such as product logos, shape outlines, and distinctive arrangement of buttons and panels. The CNN for pattern recognition is trained on labeled images of product fronts, sides, and labels. During inference, the server converts the input image into a normalized tensor (for example, normalized pixel values and fixed resolution), feeds the tensor into the CNN, and obtains a probability distribution over known product classes.

The server aggregates the character information and pattern information into identification information and feature information. The server normalizes the character strings by removing spaces, hyphens, and non-alphanumeric characters, converting letters to a consistent case, and applying predefined mapping rules for frequently seen variations of model codes. The server integrates the normalized strings with pattern-based class probabilities to compute a final product identification information. For example, the server computes a weighted score that combines OCR confidence scores and CNN class probabilities, and selects the product identifier with a maximum combined score exceeding a threshold.

The server stores a product information database in the information storage apparatus, which may be implemented as a relational database management system. The database stores product information, including product identifiers, categories, and links to document information such as manuals, safety instructions, and frequently asked questions. The server accesses the database using a query language such as a structured query language. The server issues queries using the normalized product identification information as a key, for example by matching on a model identifier field or on a combination of category and model fields. The server retrieves document information associated with the target product from the database. The document information is stored as text or semi-structured data including section headings, paragraphs, and tags indicating topics such as “Timer Setting,” “Cleaning,” “Installation,” and “Troubleshooting.” The server loads the document information into memory and organizes it into structured data objects including arrays of sections and sentences. The server uses term frequency statistics or semantic embeddings to measure similarity between user questions and document sections, so that only relevant segments of document information are passed forward.

The user provides a natural language inquiry via the terminal by entering text or by speaking into the microphone. The terminal optionally uses a speech recognition service to convert audio data into text. The terminal transmits the question text to the server along with identifiers that associate the question with the previously transmitted image and the identified product.

The server receives the question text and applies a text pre-processing module that normalizes punctuation, removes extraneous whitespace, and detects the language of the question. The server then selects, from the document information associated with the target product, segments that are most relevant to the question. In one embodiment, the server represents each document sentence and the question as vectors in a semantic space produced by a sentence encoding model, and computes cosine similarity to select top-ranked sentences. By limiting the number of sentences and sections passed to subsequent processing, the server reduces the amount of data that must be processed by the generative AI model.

The server constructs a prompt sentence for the generative AI model. The server concatenates: (i) a structured description of the product, (ii) the selected document excerpts, and (iii) the user's natural language inquiry, together with explicit instructions that constrain the behavior of the generative AI model. For example, the server may generate a prompt sentence as follows:
“Product: microwave oven, model XYZ123.

### Relevant Manual Content

1. To set the timer, press the TIMER button.
2. Turn the dial to select the desired time.
3. Press the START button to begin counting down.
User question: ‘How do I set the timer on this microwave?’
Using only the relevant manual content above, generate a clear, step-by-step answer for the user. Do not invent features that are not described.”

In another example concerning an air conditioner, the server may generate a prompt sentence as follows:
“Product: Air conditioner, model AC-4500.

### Relevant Manual Content

Turn off the power before cleaning the filter.
Open the front panel, remove the filter, wash it with lukewarm water, dry it completely in the shade, and reinstall it.
User question: ‘Tell me how to clean the filter.’
Based on the product information and manual content above, answer the user's question in a concise, step-by-step manner, and include any safety precautions.”

The server uses a generative AI client module to send the constructed prompt to a generative AI model provided on a remote computation platform or locally. In one embodiment, the generative AI model is implemented as a large language model using a transformer architecture including multiple attention layers, feed-forward layers, layer normalization, and positional encodings. The model is trained in advance on a large corpus using an objective such as next-token prediction, with a loss function such as cross-entropy. The model parameters (weights and biases) are optimized through gradient-based optimization and stored in the model execution environment.

During operation, the server transmits the prompt sentence to the generative AI model via an application programming interface, together with hyperparameters such as a sampling temperature and a maximum number of output tokens. The generative AI model processes the prompt by converting tokens into continuous vector embeddings, applying multi-head attention and feed-forward operations through multiple layers, and generating a probability distribution for each next token. The model iteratively selects tokens according to a sampling strategy and outputs the answer text. The server receives the generated answer text as a sequence of characters or tokens.

The server executes the reliability evaluation module on the answer text. In one embodiment, the server computes similarity scores between the answer text and the underlying document information, checks for the presence of mandatory safety terms when certain topic tags (for example, cleaning or installation) are involved, and evaluates whether prohibited expressions or unsupported functions are mentioned. The server uses rule-based filters combined with a classifier implemented as another neural network to assign a reliability score. If the reliability score is below a predetermined threshold, the server routes the prompt and the answer text to a human response support apparatus. The human operator views the proposed answer, adds supplementary information or corrections, and sends modified content back to the server, which integrates the modifications into the final response data.

The server performs response formatting processing on the answer text or the corrected content. The server inserts line breaks, headings, bullet points, and numbering to make the answer easier to read on the terminal's display. The server may also insert references to related sections in the manual stored in the database by embedding links or identifiers. The server generates response data that includes the formatted answer text and metadata such as the product model, topic tags, and confidence scores.

The server optionally converts the answer text portion of the response data into audio data using speech synthesis software. The server uses a text-to-speech engine that converts text to a phoneme sequence, applies a prosody model to generate pitch and duration, and uses a waveform synthesis model such as a parametric vocoder or a neural waveform model to generate an audio waveform. The server produces an audio file in a digital audio format and includes it in, or provides a reference to it from, the response data transmitted to the terminal. The terminal receives the response data from the server and displays the formatted answer text on the display. The terminal also plays the audio data through the speaker when the user initiates playback. The user can thus obtain instructions on how to operate or maintain the product without manually searching through a full manual.

In some embodiments, the server estimates an emotional state of the user from audio data, image data, or text data transmitted by the terminal. For example, the terminal may send a short audio sample of the user's voice when the question is recorded. The server extracts acoustic features such as pitch variability, speaking rate, and energy, and uses a classifier network trained on labeled emotional speech data to estimate whether the user is frustrated, calm, or confused. The server can also analyze facial expressions in a user image using a CNN trained for facial emotion recognition, and analyze linguistic markers in the question text using a text classifier. The server combines these signals into an emotional state score. The server adapts the description style of the prompt and the expression style of the response data according to the emotional state. For example, if the user appears frustrated, the server modifies the prompt to instruct the generative AI model to produce a shorter, more direct answer with explicit reassurance, and the server simplifies the wording and increases step-wise granularity in the response. By systematically altering prompts and responses based on quantitative emotional estimates, the server achieves more stable and appropriate outputs from the generative AI model and reduces the likelihood of user dissatisfaction.

The described architecture provides technical advantages under computer-implemented conditions. The server's use of image analysis and structured product identification reduces ambiguity at an early stage, which decreases the number of candidate products and associated documents that must be processed. This reduction leads to lower memory consumption and faster query execution within the database. The prompt construction module ensures that the generative AI model is constrained to a limited and contextually relevant set of document excerpts, thereby improving answer accuracy and reducing computational cost for inference. Because the prompt is structured and includes explicit instructions tied to product documents, the model is less likely to generate irrelevant or unsupported content, which directly improves reliability and reduces the need for repeated user queries.

In contrast to a mere automation of manual reading of manuals, the server reorganizes data into specific internal data structures (for example, normalized identifiers, semantic vectors, ranked sections, and structured prompts) and applies non-conventional control logic between the image analysis pipeline, the database retrieval pipeline, and the generative AI inference pipeline. The server selectively discards low-relevance data before it reaches the generative AI model, which reduces network traffic between the server and any external model provider, and reduces the number of computation steps executed by the model. This selective pre-filtering and structured prompting provide a technical improvement to the overall computing system by lowering latency and resource usage while maintaining or improving the quality of the answers.

The training process of the neural networks used for OCR, pattern recognition, semantic similarity estimation, emotional state classification, and reliability evaluation is performed prior to deployment. The server stores training data sets including labeled images of products and labels, transcribed text with ground-truth model numbers, emotional speech samples, and pairs of document segments and questions with relevance labels. The server or an associated training system uses a machine learning library to initialize network weights, compute loss functions such as cross-entropy or mean squared error, perform backpropagation to calculate gradients, and update weights via an optimization algorithm such as stochastic gradient descent or an adaptive method. The trained weights are then fixed and used in the production system for inference only. This separate training process ensures that the deployed system behaves deterministically given the same inputs, which is important for repeatability and validation.

Alternative embodiments of the system may vary the internal components while preserving the overall functional structure defined by the claims. For example, the server may use different database architectures such as a document-oriented database or a key-value store, provided that the server still matches product identification information to stored product and document records. The server may use different neural network architectures, such as recurrent neural networks, transformers, or hybrid models for OCR and pattern recognition, as long as the server extracts character information and pattern information that support the identification of the product. The generative AI model may be executed locally on the server's hardware accelerators or remotely on a shared computation platform. The speech synthesis software may use different waveform generation techniques or voice models, but in each case converts text-based answers into audible speech for the terminal.

In another embodiment, the server may maintain a cache of frequently requested product manuals and associated semantic representations so that retrieval and prompt construction can be performed more quickly for popular products. The server may additionally implement compression of intermediate data structures to reduce memory and storage requirements. By integrating these variations, the system can be scaled to handle a large number of concurrent user requests while maintaining low answer latency and high reliability.

Through the described configuration, the server, the terminal, and the generative AI model collectively implement a technical solution that improves computer operation in the context of product support. The use of specialized neural networks for image and text understanding, combined with structured prompt sentences and reliability-aware post-processing, leads to better utilization of computational resources, improved throughput, and reduced error rates, thereby providing a concrete improvement over conventional systems that simply provide unstructured access to generic question-answering engines.

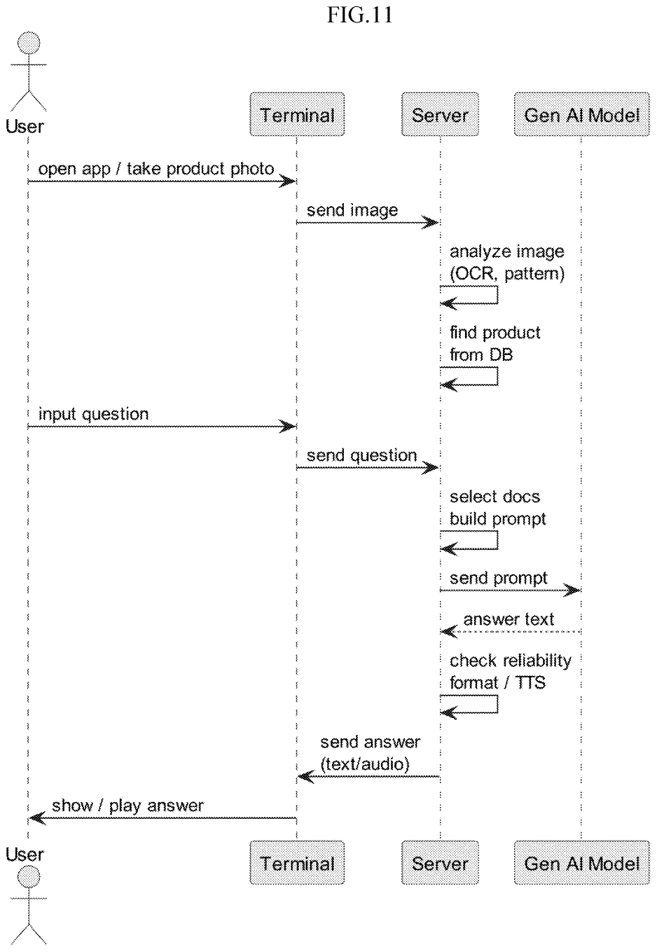

The following describes the processing flow using FIG. 11.

### Step 1

The user operates the terminal to start an inquiry application and capture an image of a product.
The input is the real-world scene including the product and its label.
The terminal controls the built-in camera through an operating system camera API, focuses on the product label, and captures a digital image.
The terminal stores the captured image as image data in a compressed format such as JPEG or PNG in local storage.
The output is a compressed image file that visually includes the product and associated characters such as a model number.

### Step 2

The terminal prepares transmission data and sends the image to the server.
The input is the compressed image file produced in Step 1 and session metadata such as device ID and timestamp.
The terminal optionally resizes the image to a target resolution and attaches the image file to an HTTP or HTTPS request using a multipart/form-data body.
The terminal opens a network connection over a communication network and transmits the request to the server.
The output is an HTTP or HTTPS request containing the image data and metadata, delivered to the server.

### Step 3

The server receives and stores the image data.
The input is the HTTP or HTTPS request carrying the image data from the terminal.
The server validates the request, checks headers and file size, and writes the image data to a storage device under a unique file path while generating an internal image identifier.
The output is an internally stored image file and an image identifier referenced in server-side session data.

### Step 4

The server decodes the image and performs low-level image preprocessing.
The input is the stored image file and its identifier.
The server uses image processing software to decode the compressed image into a pixel array and applies preprocessing operations such as grayscale conversion, noise reduction, contrast enhancement, and region-of-interest cropping.
The server adjusts pixel values and dimensions to match the expected input shape of downstream neural networks.
The output is a normalized image tensor representing the preprocessed image.

### Step 5

The server executes character region detection and optical character recognition.
The input is the normalized image tensor from Step 4.
The server applies a convolutional neural network or similar detector to locate regions that are likely to contain text, crops those regions, and feeds each region into an OCR network.
The server performs forward propagation through the OCR network, converting image patches into sequences of characters with confidence scores.
The output is character information including one or more character strings (for example, potential model numbers and codes) and associated confidence values.

### Step 6

The server executes pattern recognition to detect logos and product shapes.
The input is the normalized image tensor from Step 4.
The server runs a pattern recognition model, such as a convolutional neural network trained on product images, to compute feature maps and classify the product into one or more candidate categories with probabilities.
The server may also detect specific logo patterns or layout patterns that are characteristic of particular product families.
The output is pattern information consisting of predicted product classes, logo identifiers, and their confidence scores.

### Step 7

The server generates identification information and feature information from extracted data.
The input is the character information from Step 5 and the pattern information from Step 6.
The server performs string normalization such as removing spaces and hyphens, converting to uppercase, and mapping known variations to canonical codes, and combines these normalized strings with category probabilities from pattern recognition.
The server calculates a composite score for candidate identifiers using a weighted combination of OCR confidence and pattern recognition probabilities, and selects the most plausible identifier.
The output is identification information (for example, a canonical model code) and feature information (for example, category, series, or form factor).

### Step 8

The server matches the identification information against a product information database.
The input is the identification information and feature information from Step 7.
The server constructs database queries using a query language and sends them to an information storage apparatus containing product records and document records.
The server filters results based on exact matches or closest matches to model fields, category fields, and manufacturer fields, and resolves conflicts if multiple records are returned.
The output is a target product record and associated document information such as manuals and FAQ entries.

### Step 9

The server structures and indexes the document information for later retrieval.
The input is the raw document information retrieved in Step 8.
The server decomposes the documents into sections, headings, and sentences, and stores them in internal data structures such as arrays or lists.
The server computes auxiliary data, such as keyword indexes or semantic embeddings for each sentence, to accelerate later relevance scoring.
The output is structured document data, including sections with identifiers and precomputed features for similarity calculations.

### Step 10

The user inputs a natural language inquiry related to the product.
The input is the user's intent to ask a question about the identified product.
The user types a question using a text input field on the terminal or speaks into the microphone to record audio.
The terminal optionally converts recorded audio to text using a speech recognition function and displays the recognized text to the user.
The output is a question text string representing the user's inquiry.

### Step 11

The terminal transmits the question text to the server.
The input is the question text from Step 10 and a session identifier linking the question to the earlier image.
The terminal encapsulates the question text and session identifier in an HTTP or HTTPS request or a WebSocket message and sends it to the server.
The output is a network message carrying the question text received by the server.

### Step 12

The server normalizes the question text and determines the language.
The input is the question text received in Step 11.
The server removes extraneous whitespace, standardizes punctuation, and applies a language detection algorithm based on character patterns or statistical models to identify the language used in the question.
The server updates internal fields that indicate the language and normalized text for use in subsequent matching and prompt construction.
The output is a normalized question text string and language metadata.

### Step 13

The server selects relevant document segments based on the question.
The input is the normalized question text from Step 12 and the structured document data from Step 9.
The server computes similarity scores between the question and each document sentence using an algorithm such as cosine similarity in an embedding space or term-based scoring, and ranks the sentences or sections by relevance.
The server selects top-ranked sentences and their parent sections, subject to a token or character limit, to ensure that only highly relevant document segments are used.
The output is a subset of document segments and associated metadata, representing information most relevant to the question.

### Step 14

The server estimates a user emotional state, if emotional data is available.
The input is optional audio data, image data of the user, and text data associated with the session.
The server extracts features such as pitch, speech rate, facial expression indicators, and word usage patterns, and feeds these features into trained classification models to assign scores for different emotional categories.
The server summarizes the scores as an emotional state indicator, such as calm, frustrated, or confused, stored in the session context.
The output is an emotional state descriptor or score that can influence prompt style and response style.

### Step 15

The server constructs a context-aware prompt sentence for a generative AI model.
The input is the target product record from Step 8, the selected document segments from Step 13, the normalized question text from Step 12, and optionally the emotional state from Step 14.
The server assembles a prompt by concatenating product description, relevant manual content, the user's question, and explicit instructions regarding style and constraints; if the emotional state indicates frustration, the server adjusts wording to be more concise and reassuring.
The server ensures that the final prompt sentence length and structure are within limits accepted by the generative AI model and that references to product features are consistent with the retrieved documents.
The output is a prompt sentence text string designed to guide the generative AI model.

### Step 16

The server sends the prompt sentence to the generative AI model and obtains answer text.
The input is the prompt sentence from Step 15 and model configuration parameters such as temperature and maximum output length.
The server invokes an interface for the generative AI model, transmits the prompt and parameters, and receives generated tokens as the model executes its internal neural network operations to produce a natural language answer.
The server concatenates the received tokens into a complete text string representing the answer.
The output is answer text describing a response to the user's question about the target product.

### Step 17

The server evaluates the reliability of the generated answer text.
The input is the answer text from Step 16, the selected document segments from Step 13, and product metadata.
The server computes similarity between the answer and the underlying document text, checks for required safety phrases when specific topics are detected, and verifies that the answer does not mention unsupported functions or contradict known product limitations.
The server combines rule-based checks and classifier outputs into a reliability score and compares the score with a predetermined threshold value.
The output is a reliability score and a decision indicating whether the answer is acceptable or requires human intervention.

### Step 18

The server optionally requests human correction when reliability is low.
The input is the answer text and reliability decision from Step 17.
The server forwards the prompt sentence and the generated answer text to a human response support apparatus when the reliability score is below the threshold, and waits for supplementary information or corrections typed by a human operator.
The server merges the received corrections with the original answer text, replacing or augmenting sections as indicated by the operator.
The output is a finalized answer text that has either passed automated reliability checks or has been human-corrected.

### Step 19

The server formats the finalized answer text and generates response data.
The input is the finalized answer text from Step 18 and contextual metadata such as product model and topic tags.
The server inserts appropriate headings, bullet points, numbering, and line breaks, and may add references to product document sections, generating a structured answer suitable for display on a terminal.
The server encapsulates the formatted text and metadata into a response data object.
The output is response data containing formatted answer text ready for transmission.

### Step 20

The server optionally converts the answer text into audio data.
The input is the finalized answer text from Step 18 or the formatted text from Step 19 and a flag indicating that audio output is desired.
The server uses speech synthesis software to convert the text into a sequence of phonetic units, applies a prosody model, and generates a digital audio waveform, which is encoded as an audio file.
The server adds a reference to this audio file or embeds the audio data into the response data object.
The output is response data that includes or references audio data corresponding to the answer text.

### Step 21

The server transmits the response data to the terminal.
The input is the response data from Step 19 or Step 20 and the session identifier.
The server serializes the response data into a network message, such as a JSON body in an HTTP or HTTPS response or a WebSocket message, and sends it over the communication network to the terminal associated with the session.
The output is a network message delivering the response data to the terminal.

### Step 22:

The terminal presents the answer to the user.
The input is the response data received from the server in Step 21.
The terminal parses the response data, renders the formatted answer text on the display using its user interface toolkit, and, if audio data is included, initializes an audio playback component to output the synthesized speech through the speaker when the user activates playback.
The output is a presented answer, in text and optionally audio form, that the user can perceive and use to operate or understand the product.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional product information systems deployed in retail environments typically rely on static databases and fixed retrieval logic to provide product descriptions, specifications, and frequently asked questions. In such systems, a server generally responds to a user query by matching a limited set of identifiers, such as a product code or barcode, to pre-authored text stored in a data repository. This architecture exhibits several technical drawbacks.

First, the server is not optimized to interpret rich sensor data, such as product images captured by a user terminal, in a way that robustly identifies a target product under varying imaging conditions. Noise and variation in image data, including differences in lighting, angle, and occlusion, can cause inaccurate or failed product recognition when only simple pattern matching or basic image classifiers are used. As a result, the server may either return irrelevant product information or be unable to return any information, thereby degrading usability and requiring repeated network transactions and retries.

Second, even when a target product is correctly identified, conventional systems deliver lengthy and unstructured document data, such as entire manuals or full FAQ lists, to the user terminal. This results in excessive data transmission, increased processing load on the server and the terminal, and inefficient user interaction. The user is forced to manually search long documents, leading to high latency from the time of query to the time of obtaining useful information, and increasing the number of user inputs and server queries.

Third, systems that integrate generative AI components typically rely on simple, unstructured prompts directly derived from user queries and raw document text. Without explicit control over which document elements are supplied to the generative AI model, the server can generate unnecessarily large prompt payloads, causing excessive consumption of computational resources, longer response times, and possible context truncation in the generative AI model. This reduces the accuracy and relevance of generated answers and complicates scaling the system to many concurrent users.

Fourth, conventional architectures often reset the context of each query and do not systematically maintain an evolving interaction state across multiple turns of a dialog. This lack of structured, stateful prompt updating prevents efficient reuse of previously retrieved product information and previously generated answers. As a result, the server redundantly performs similar database lookups and text processing for each new question, increasing server load and network traffic, and decreasing the responsiveness of the system from the user's perspective.

Accordingly, there is a need for an improved computer-implemented system and server architecture that: (i) reliably extracts product identification and attribute information from image data obtained by a user-operated terminal; (ii) selectively retrieves and structures only those document elements relevant to a target product and a user inquiry; (iii) constructs and updates prompt sentences in a controlled manner to optimize the input to a generative AI model; and (iv) supports dialog-style interactions while reducing redundant processing and improving throughput, latency, and resource utilization of the overall system. The technical problem to be solved is therefore to improve the functioning of the server and the associated computer network system itself, by reducing unnecessary data movement and processing, increasing robustness of product identification from images, and enhancing the efficiency and quality of answer generation using a generative AI model.

The specific processing by the specific processing unit 290 of the data processing device 12 in Application Example 1 is realized by the following means.

The present invention provides a server comprising a processor and a memory storing instructions, wherein the processor is configured to analyze image data including a product, the image data being acquired from an information processing terminal operated by a user, by using image processing technology, and to extract product identification information and product attribute information from the image data; to search, based on the extracted product identification information and the product attribute information, an information storage device storing document data relating to products, and to identify document information corresponding to a target product from the document data; to classify a plurality of document elements extracted from the document data for each product characteristic and to select, based on a classification result, document elements to be included in a prompt sentence; to construct, based on the identified document information relating to the target product, the selected document elements, and inquiry information acquired from the user, the prompt sentence to be input to a generative information processing model, to supply input data including the prompt sentence to the generative information processing model, and to cause the generative information processing model to generate answer information in a natural language; to sequentially update the prompt sentence by using additional inquiry information acquired from the information processing terminal and the document information corresponding to the target product, and to repeatedly execute generation processing of the answer information by the generative information processing model so as to provide product information in a dialog format; and to output, based on the generated answer information, explanation information relating to the target product as visual information to the information processing terminal, to convert the answer information into audio data by using speech synthesis technology, and to output the audio data to the information processing terminal. This enables the server to more efficiently and reliably identify a target product from user-captured image data, to minimize and structure the document content supplied to the generative AI model via optimized prompt sentences, to maintain and reuse dialog context across multiple user inquiries, and thereby to reduce computational load and network traffic while improving response time, relevance, and clarity of product information presented to the user.

The term “system” refers to a combination of hardware and software components including at least one server and at least one information processing terminal that cooperate to execute the processing described in the claims.

The term “processor” refers to a hardware computation unit, such as a central processing unit or a graphics processing unit, that executes instructions to perform data processing, control, and communication functions of the server.

The term “memory” refers to a non-transitory computer-readable storage medium, such as semiconductor memory or magnetic storage, that stores instructions and data to be executed or used by the processor.

The term “information processing terminal” refers to an electronic device operated by a user, such as a portable communication device, a tablet device, or a personal computer, that captures images, sends inquiries, and receives product information.

The term “user” refers to a person who operates the information processing terminal to capture product images, input inquiries, and receive product information.

The term “image data” refers to digital data representing a still or moving image, including pixel values or encoded image files, that depict at least one product.

The term “image processing technology” refers to software-implemented algorithms for analyzing image data, including techniques such as feature extraction, pattern recognition, or classification used to derive information from the image data.

The term “product identification information” refers to data that uniquely or specifically identifies a product, such as a model code, product name, category identifier, or similar identification code derived from the image data.

The term “product attribute information” refers to data representing characteristics or properties of a product, such as specifications, functions, performance parameters, appearance attributes, or configuration details derived from the image data.

The term “information storage device” refers to a data storage apparatus, such as a database system or file storage system, that stores document data relating to multiple products.

The term “document data” refers to electronic text data or structured data describing products, including manuals, specification sheets, frequently asked questions, or other product-related documents.

The term “document information” refers to a subset of document data that has been identified as associated with a particular target product.

The term “target product” refers to a specific product that is determined, based on analysis of image data and associated information, to be the subject of a user inquiry and subsequent information retrieval.

The term “document element” refers to a portion of document data, such as a paragraph, sentence, section, field, or record, that can be individually selected or classified for use in prompt construction.

The term “product characteristic” refers to a category or type of product attribute, such as battery performance, imaging function, display property, connectivity function, or warranty condition, used as a basis for classifying document elements.

The term “inquiry information” refers to data representing a question, request, or instruction from the user regarding a product, typically expressed as text input or a selected option transmitted from the information processing terminal.

The term “additional inquiry information” refers to inquiry information that is received after an initial inquiry, in a subsequent turn of an interaction, and that further refines, extends, or follows up on a previous question.

The term “prompt sentence” refers to text data constructed by the processor that is supplied as input to a generative information processing model, the text data including instructions, product context, document elements, and user inquiry information.

The term “input data” refers to data supplied to the generative information processing model, including at least the prompt sentence and optionally additional context parameters.

The term “generative information processing model” refers to a software-implemented model, such as a generative artificial intelligence model or a large language model, that generates natural language output based on input data including the prompt sentence.

The term “answer information” refers to natural language text generated by the generative information processing model in response to the prompt sentence and representing an answer to a user inquiry.

The term “generation processing” refers to processing executed by the generative information processing model to produce answer information from input data including the prompt sentence.

The term “explanation information” refers to information derived from the answer information and formatted for presentation, including summarized, structured, or otherwise processed text describing the target product.

The term “visual information” refers to information represented in a form suitable for display on a screen of the information processing terminal, including text, icons, or graphical elements.

The term “audio data” refers to digital data representing sound, such as encoded audio waveforms, that is generated by converting the answer information using speech synthesis technology.

The term “speech synthesis technology” refers to software-implemented techniques for converting text data into audio data that reproduces human-like speech.

The term “display device” refers to a hardware component of the information processing terminal, such as a liquid crystal display or an organic light-emitting diode display, that visually presents information to the user.

The term “acoustic output device” refers to a hardware component capable of outputting sound, such as a speaker or an earphone, that reproduces audio data for the user.

The term “control information” refers to data transmitted from the server to the information processing terminal that instructs the terminal to perform operations such as displaying visual information or reproducing audio data.

The term “dialog format” refers to an interaction mode in which multiple turns of inquiries and responses are exchanged over time between the user and the system, with the system maintaining and updating context across the turns.

The server, the terminal, and the user cooperate to implement embodiments of the present invention as described below. In each embodiment, the server executes computer-implemented processing using specific hardware and software components, and the terminal executes complementary processing to capture, transmit, and present data. The user interacts with the system primarily through the terminal.

The server in one embodiment includes at least one processor, a main memory, a non-transitory storage device, a communication interface, and optionally a hardware accelerator such as a graphics processing unit. The server executes an operating system such as a general-purpose server operating system and application software implementing an image recognition module, a document retrieval module, a prompt construction module, a generative AI interface module, and a text-to-speech module. The server stores product-related document data and related index data in a database management system, which may be implemented using a relational database engine. The server connects to an external generative AI model service via a network using an application programming interface.

The terminal in one embodiment includes a processor, a memory, a display device, a camera, one or more acoustic output devices such as speakers or earphones, a microphone, and a wireless communication interface. The terminal executes a mobile operating system such as a smartphone operating system and a dedicated application that communicates with the server using a secure network protocol. The terminal uses the camera to capture product images, the display to present product information, and the acoustic output device to reproduce audio information received from the server. The user operates the terminal via a touch-sensitive display or similar input interface.

The server uses specific software libraries for technical processing. For image analysis, the server uses an image processing library such as a general-purpose computer vision library and a machine learning framework such as a general-purpose deep learning framework. For text-to-speech processing, the server uses a text-to-speech engine such as a cloud-based speech synthesis service. For database access, the server uses drivers compatible with the chosen database engine. For communication with the generative AI model, the server uses a network client library that sends and receives data using a structured text format. The server stores the generative AI model either locally or accesses it as a remote service. In one embodiment, the generative AI model is a transformer-based large language model having an encoder-decoder or decoder-only architecture. The model comprises a plurality of self-attention layers, each layer including multi-head attention mechanisms, feed-forward networks, layer normalization, and residual connections. The model parameters, including attention weights and feed-forward layer weights, are stored in non-transitory memory and are applied to tokenized input sequences to compute probability distributions over output tokens. The server does not treat the generative AI model as a black-box; instead, the server controls the model's behavior by explicitly structuring the input token sequence through a carefully constructed prompt sentence and, in some variants, by specifying decoding parameters such as maximum output length, sampling temperature, and nucleus sampling threshold.

The server implements an image recognition model for product identification. In one embodiment, the server uses a convolutional neural network implemented in the deep learning framework. The network may include multiple convolutional layers, pooling layers, and fully connected layers, optionally followed by a softmax output layer that outputs a probability distribution over product class identifiers. The server feeds normalized pixel data derived from the terminal-captured image into the network. The server obtains an output vector of class probabilities and selects one or more top-ranked classes as candidate product identifiers. In another embodiment, the server uses a combination of a convolutional backbone and an optical character recognition model to detect and recognize textual labels (such as model numbers) present in the image. The server combines the class probability output and the recognized text using a heuristic or rule-based fusion algorithm, where the server assigns weighted scores to each candidate based on image classification confidence and text recognition confidence, and selects a target product identifier when a combined score exceeds a threshold.

The server trains the image recognition model in advance using a dataset of labeled product images. The server preprocesses training images using data augmentation techniques such as random cropping, rotation, scaling, brightness adjustment, and color jittering. The server uses a loss function such as cross-entropy loss between predicted class probabilities and ground truth labels. The server updates the model weights using an optimization algorithm such as stochastic gradient descent with momentum or an adaptive gradient method. The server iteratively adjusts the weights to minimize the loss across the training dataset, thereby improving recognition accuracy under diverse imaging conditions.

The server organizes product-related document data using a structured schema. In one embodiment, the server stores document data in a database table structure with fields such as product identifier, document type, section identifier, section heading, and section content. The server indexes the data by product identifier and section heading to enable efficient retrieval. The server may store additional metadata such as language, version, and creation date. The server reduces the amount of data to be sent to the generative AI model by pre-classifying document elements into product characteristics such as power-related characteristics, imaging-related characteristics, display-related characteristics, connectivity-related characteristics, and warranty-related characteristics.

The server performs document element classification using either a rule-based algorithm, a machine learning classifier, or a hybrid approach. In one embodiment, the server applies keyword-based rules that detect terms such as “battery,” “capacity,” “standby time,” and “charging” to classify sections as power-related. In another embodiment, the server uses a text classifier implemented as a shallow neural network or a transformer encoder fine-tuned on labeled document segments. The server represents each section as a numerical vector using techniques such as term frequency-inverse document frequency, word embeddings, or contextual embeddings, and applies a classifier to assign one or more characteristic labels to each section.

The server constructs a prompt sentence in a controlled manner. The server does not simply concatenate the entire product manual and the user question. Instead, the server selects a subset of document elements based on the product characteristics inferred from the user inquiry and from the recognized product attributes. For example, when the user asks about battery life, the server selects battery-related sections, power-saving tips, and relevant FAQ entries, and excludes unrelated content such as packaging information or legal disclaimers. The server then concatenates system-level instructions, product metadata, selected document elements, and the user question to form a prompt sentence for the generative AI model.

The server may generate prompt sentences such as:
“You are a product support assistant. Answer the user's question using only the provided product documents and FAQs. Do not invent specifications.
Product: Smartphone Model A.
Documents (manual and FAQ excerpts): [battery section text] [relevant FAQ entries].
User question: How long does the battery last during typical daily use?”

The server may also generate prompt sentences such as:
“Using only the product documents below, summarize the main features of this product, including battery, camera, and display, in less than 200 words so that a non-expert user can easily understand.
Product: Smartphone Model A.
Documents: [specification sheet excerpts].”

The server may further generate prompt sentences such as:
“From the following manual and FAQ excerpts, create a list of frequently asked questions and answers about this product, prioritizing battery life, camera performance, and warranty conditions.
Documents: [FAQ and manual sections].”

The server uses an internal representation of the prompt sentence as an ordered sequence of tokens. The server performs tokenization using a model-compatible tokenizer such as a byte-pair encoding tokenizer or a sentencepiece tokenizer. The server counts the number of tokens to ensure that the total length does not exceed the generative AI model's input limit. When necessary, the server truncates or summarizes less relevant sections before including them in the prompt. By managing the prompt at the token level, the server reduces input size, thereby decreasing network bandwidth usage and inference time at the generative AI model.

The server interacts with the generative AI model through a defined interface. The server packages the tokenized prompt and associated parameters into a request and sends it via the communication interface to the generative AI service. The server receives a token sequence representing the answer information from the generative AI service. The server converts tokens to text using the model's decoder and obtains answer information in natural language. The server may apply post-processing rules such as enforcing a maximum number of sentences, segmenting the answer into bullet points, and inserting headings for readability. Because the server controls the structure and content of the prompt and the post-processing of the response, the system achieves a level of technical optimization and predictability not possible in conventional systems that simply forward arbitrary user input to an AI service. The server maintains dialog context across multiple user turns. The server stores the previous prompt content, previous user inquiries, and previously generated answer information in a context data structure. The server, upon receiving an additional inquiry from the terminal, updates the context data structure and reconstructs a new prompt sentence that includes a compressed representation of the prior dialog, selected document elements, and the new user inquiry. The server may apply a context summarization algorithm that compresses prior dialog turns into a shorter, semantically representative text to maintain coherence while staying within token limits. By explicitly managing dialog state, the server reduces redundant database queries and repeated document processing for each new inquiry, thereby reducing processor load and improving response times.

The server converts the answer information into audio data using speech synthesis technology. The server calls a text-to-speech engine with parameters specifying language, voice type, and output format. The text-to-speech engine applies a sequence-to-sequence model or a parametric synthesis model to map text to acoustic features and then to waveform samples. The server receives the generated audio data and stores it in a compressed format such as a common audio encoding format. The server then sends the audio data together with the text-based explanation information to the terminal.

The terminal presents the explanation information and audio data to the user. The terminal displays the explanation information on the display device, using layout and styling optimized for readability. The terminal decodes the audio data and outputs sound through the acoustic output device. The user can read detailed specifications and simultaneously listen to an audio explanation. The terminal may also provide user interface elements for submitting additional inquiries, which the terminal sends to the server for further dialog processing. The system provides technical improvements beyond mere automation of human tasks. By using image-based product recognition and structured prompt construction, the server reduces the amount of data transmitted and processed compared to systems that send entire manuals or rely solely on text searches. The server improves the accuracy of product identification by combining neural network classification and text recognition with a score fusion algorithm, thereby reducing misidentification rates under challenging imaging conditions. The server improves computational efficiency by classifying document elements and selectively including only relevant sections in the prompt, reducing the required number of tokens, and thus lowering both inference cost and latency in the generative AI model. The system improves data management by organizing documents into characteristic-based categories and reusing this organization across many queries.

The server applies non-conventional processing steps that are not a simple computer implementation of a manual procedure. A human operator does not naturally optimize token length for a language model or manage context embeddings, whereas the server uses explicit token counting, context summarization algorithms, and characteristic-based section selection to tailor the input to the generative AI model. The server, by performing these specific and structured operations, changes the way the computer system allocates memory, CPU cycles, and network bandwidth. The server thus improves the functioning of the computer network itself.

In alternative embodiments, the server may host the generative AI model locally instead of using an external service. In such embodiments, the server loads model weights from local storage into memory and executes the transformer inference on a hardware accelerator. The server may use mixed-precision computation, such as half-precision floating point, to accelerate matrix multiplications and reduce memory usage. The server may also adjust beam search or sampling strategies to trade off between answer diversity and response time, according to system configuration.

In further embodiments, the server may use different neural network architectures for image recognition, such as vision transformers or hybrid convolutional-transformer networks. The server may also use different document classification methods, such as graph-based clustering of document sections or attention-based models that learn the importance of document elements with respect to typical user queries. The server may support multiple languages by storing language-specific document versions and by specifying appropriate language codes in prompt sentences and speech synthesis parameters.

The terminal may also vary in form factor. In some embodiments, the terminal is a wearable device with a head-mounted display and an embedded camera. In other embodiments, the terminal is a fixed kiosk in a retail store, equipped with a large display and a high-resolution camera. In each case, the terminal captures images, sends them to the server, and receives text and audio information in substantially similar data formats.

Through these embodiments, the system achieves technical effects including improved recognition accuracy for products under real-world imaging conditions, reduced bandwidth consumption between the server and the generative AI model, reduced latency for delivering relevant answers to the user, and improved utilization of server resources. The server leverages specific data structures, algorithms, model architectures, and network protocols to realize these effects, thereby providing an improvement in computer technology rather than merely implementing an abstract business process.

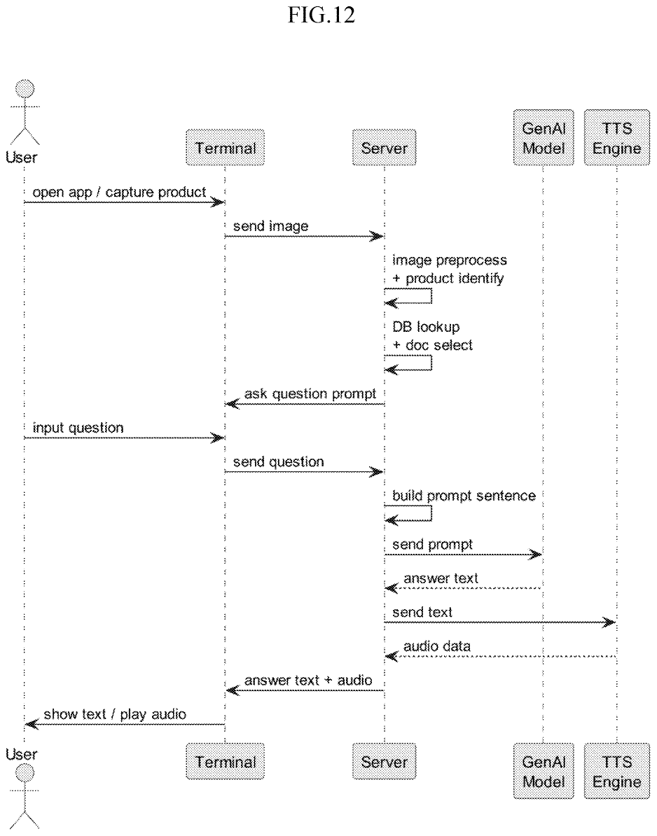

The following describes the processing flow using FIG. 12.

### Step 1

The user operates the terminal to start a product information application and to capture an image of a physical product. The terminal receives user input from a touchscreen to activate a camera function, controls a built-in camera sensor to acquire raw image signals, and converts the signals into a digital image file in a compressed format. The terminal sets the captured image as the input for subsequent processing. The output of this step is image data representing the product, stored temporarily in the terminal's memory.

### Step 2

The terminal prepares the captured image data and related metadata for transmission to the server. The terminal takes the image file as input, reads its binary contents, attaches device identifiers, time stamps, and optionally location information, and constructs a network request using a secure communication protocol. The terminal then outputs a formatted request message that includes the image data and metadata, and transmits this request to the server over a communication network.

### Step 3

The server receives the network request from the terminal and validates the received image data. The server takes as input the incoming request message, parses the message to extract the image file and metadata, checks the file type and size, and stores the image in a temporary storage area. The server outputs a normalized representation of the image data, for example, as a matrix of pixel values along with an internal request identifier that links the image to the ongoing session.

### Step 4

The server performs image preprocessing to prepare the image data for product identification. The server takes as input the pixel matrix representing the image and applies image processing operations such as resizing, cropping, color space conversion, and normalization. The server uses a software library to rescale the image to a predetermined resolution and to normalize pixel values to a numeric range suitable for a neural network model. The server outputs a preprocessed image tensor that is structured as a multi-dimensional array ready to be fed into an image recognition model.

### Step 5

The server executes an image recognition model to extract product identification information and product attribute information. The server takes the preprocessed image tensor as input and feeds it into a convolutional neural network or a similar deep learning model executed by a machine learning framework. The server calculates intermediate feature maps through convolution, pooling, and activation operations and propagates these feature maps through fully connected layers to produce class probability scores. Based on these scores, the server outputs product identification information such as a model code or product class identifier. In some cases, the server additionally applies optical character recognition to the image to detect and recognize printed text, and then merges the recognized text with the classification result to output refined product identification information and initial product attribute information.

### Step 6

The server uses the extracted product identification information to query a product document database. The server takes as input the product identifier and any associated attribute information and constructs a database query using a database driver. The server executes the query against a relational database that stores document data for a variety of products. The server performs index lookups and joins across tables to locate records that match the product identifier. The server outputs document information corresponding to the target product, including manual sections, specification entries, and FAQ records, in a structured format such as a set of records or text segments.

### Step 7

The server classifies and organizes the retrieved document information according to product characteristics. The server takes as input the set of text segments or records obtained from the database and applies classification logic, which may include keyword rules or a trained text classifier, to assign characteristic labels such as battery-related, camera-related, display-related, connectivity-related, or warranty-related to each segment. The server analyzes each segment, counts occurrences of characteristic terms, or computes feature vectors and classification scores, and then groups segments by their assigned labels. The server outputs grouped document elements, each associated with one or more product characteristics.

### Step 8

The terminal acquires a specific inquiry from the user regarding the product. The user inputs a question by typing text or selecting a predefined option on the terminal's display. The terminal takes the user's input as raw text, associates it with the current session and the identified product, and packages it into a structured inquiry message. The terminal then outputs and transmits this inquiry message to the server over the network.

### Step 9

The server interprets the user inquiry and determines which product characteristics are relevant. The server takes the inquiry text and the grouped document elements as input and analyzes the inquiry using text processing techniques. The server detects keywords and phrases in the inquiry, computes similarity scores between the inquiry and characteristic labels or document segments, and identifies which characteristics (for example, battery life or camera performance) are most closely related. Based on this analysis, the server outputs a selection of document elements that are relevant to the user's question and a list of characteristic tags associated with the inquiry.

### Step 10

The server constructs a prompt sentence for a generative AI model by combining instructions, product context, selected document elements, and the user inquiry. The server takes as input the target product identifier, the relevant document elements, and the inquiry text, and uses string manipulation or template filling logic to generate a coherent text prompt. The server arranges a system directive portion, a product description portion, a document excerpt portion, and a user question portion in a predefined order, and may also calculate the token count to ensure compliance with model limits. The server outputs a complete prompt sentence that encodes all necessary context for the generative AI model.

### Step 11

The server submits the constructed prompt sentence to the generative AI model and obtains answer information. The server takes the prompt sentence as input, optionally tokenizes it into model-specific tokens, and transmits the prompt and associated parameters to an AI inference engine via an API. The server receives a sequence of output tokens or natural language text from the AI engine, decodes the tokens back into text if needed, and formats the output as answer information. The server outputs the generated answer information, which represents a natural language response addressing the user's inquiry based on the supplied document context.

### Step 12

The server updates dialog context to support multi-turn interaction. The server takes as input the newly generated answer information, the previous prompt sentence, and any prior user inquiries stored in context memory. The server aggregates these elements into a context data structure, which may include a compressed summary of previous exchanges, and stores this updated context for future use. The server outputs an updated context representation that can be used in subsequent prompt construction to maintain continuity and reduce redundant processing.

### Step 13

The server converts the answer information into audio data using speech synthesis technology. The server takes the natural language answer text as input and sends it to a text-to-speech engine with specified language and voice parameters. The server receives a stream or file of synthesized audio samples from the engine, optionally encodes or compresses the audio into a target format, and associates the audio data with the corresponding text response. The server outputs both the text-based answer information and the audio data as a unified response payload prepared for delivery to the terminal.

### Step 14

The server transmits the explanation information and audio data to the terminal for presentation to the user. The server takes as input the response payload containing the text answer, structured metadata, and audio data or an audio resource reference. The server encapsulates this payload into a response message, adds any necessary control information instructing the terminal how to display and play back the content, and sends the message over the network to the terminal. The server outputs a successfully delivered response ready for consumption by the terminal.

### Step 15

The terminal receives the response from the server and prepares the content for display and playback. The terminal takes as input the response message, parses the message to extract the answer text, metadata, and audio data or audio resource reference, and allocates memory buffers for each component. The terminal may also interpret control information that specifies layout options or playback behavior. The terminal outputs a set of prepared resources, including a text string for display and an audio buffer or reference for audio playback.

### Step 16

The terminal presents the answer information to the user through the display device and the acoustic output device. The terminal takes the prepared text string and audio data as input and renders the text in a user interface view, applying font and layout rules for readability. In parallel or on demand, the terminal decodes the audio data, feeds the decoded samples to an audio output pipeline, and drives a speaker or earphones to reproduce the sound. The terminal outputs visible content on the display and audible output from the acoustic device, enabling the user to obtain product information in both visual and auditory forms.

### Step 17

The user reviews the presented product information and may optionally submit additional inquiries for further clarification. The user takes as input the on-screen explanation and the heard audio response, compares this information with the user's own requirements or preferences, and decides whether another question is needed. If the user wishes to continue the dialog, the user enters a follow-up question through the terminal. The user's action results in new inquiry text as output, which the terminal forwards to the server, causing the processing from Step 8 onward to be repeated with updated dialog context.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented product information systems generally rely on simple keyword search over static document repositories. In such systems, a server typically receives a product identifier or a short query string from a client terminal, issues a database query using the string as a keyword, and returns raw document excerpts or links to the user. This architecture suffers from several technical limitations.

First, the server does not effectively integrate heterogeneous document sources, such as operation manuals, troubleshooting guides, and frequently asked questions, into a unified response that directly addresses a user's natural language inquiry. The server often returns lengthy or poorly focused text excerpts, forcing the user to manually scan through multiple documents on the client device. This leads to unnecessary processing cycles on the client side for repeated rendering and navigation, as well as inefficient use of network bandwidth due to transmission of redundant or irrelevant document portions.

Second, conventional systems are not designed to construct input for a generative AI model in a technically efficient manner. If a generative AI model is used at all, the server may simply forward the user's query and large volumes of unfiltered document text. This can cause the prompt to exceed model token limits, require multiple fragmentation and retry operations at the server, and induce additional memory pressure and latency in the model-serving infrastructure. The lack of controlled prompt construction and document selection leads to increased computation time, higher resource consumption, and degraded responsiveness, particularly under high load.

Third, traditional architectures do not tightly couple retrieval processing and generation processing. The document retrieval layer and the answer generation layer are often loosely integrated, with no systematic mechanism for selecting only those document segments that are most relevant to the user's inquiry and structuring them as a machine-optimized prompt sentence for the generative AI model. As a result, the server cannot consistently produce high-quality answers while respecting the computational constraints of the generative AI model, and the overall system throughput and scalability are negatively impacted.

Fourth, presentation of generated content to the user is frequently handled in an ad hoc manner. Systems may require separate applications or plug-ins to convert text responses into speech, or may not expose a consistent interface for presenting generated answers in both text and audio formats. This fragmentation adds complexity to the terminal-side software stack, increases integration overhead, and may cause duplicated processing for formatting and conversion of response data.

Accordingly, there is a need for an improved computer-implemented system and server-side processing method that: (i) systematically receives and analyzes request data including product identification information and natural language inquiries, (ii) retrieves and filters only those document segments that are relevant to the inquiry, (iii) constructs a prompt sentence that fits within the token capacity of a generative AI model and is optimized for efficient natural language processing, and (iv) generates and returns a compact response data structure suitable for presentation in both text and audio formats on the client terminal. By improving the way in which the server orchestrates document retrieval, prompt construction, and generative AI inference, the underlying computer technology can be enhanced in terms of processing efficiency, resource utilization, and response quality.

The specific processing by the specific processing unit 290 of the data processing device 12 in Example 2 is realized by the following means.

The present invention provides a server comprising a processor and a memory storing instructions that, when executed by the processor, cause the processor to receive, from an information terminal operated by a user, request data including product identification information and a natural language inquiry associated with the product identification information, analyze the request data, query, based on the product identification information, at least one document storage in an information storage device to retrieve related document information including handling information and inquiry response information, extract from the related document information one or more document segments that are relevant to the natural language inquiry, generate a prompt sentence for input to a generative AI model based on the natural language inquiry and the extracted one or more document segments, select and summarize or truncate the one or more document segments such that the prompt sentence fits within a token capacity processable by the generative AI model, cause the generative AI model to generate an answer text in a natural language by performing natural language processing using the prompt sentence, construct response data including the generated answer text, and transmit the response data to the information terminal for presentation of the generated answer text in at least one of a text format and a speech-synthesis data format. This enables the server to perform an integrated retrieval-and-generation pipeline that reduces unnecessary data transfer, constrains prompt size to the capabilities of the generative AI model, optimizes computational resource usage, and delivers focused, machine-generated answers that can be efficiently rendered as text or audio on the client terminal, thereby improving the technical performance and scalability of computer-based product information delivery.

The term “system” refers to a combination of hardware and software components that cooperate to execute the functions described in the claims, including at least a processor, a memory, and one or more communication interfaces.

The term “processor” refers to one or more processing units, such as a central processing unit, a graphics processing unit, a digital signal processor, or any other programmable computation element capable of executing instructions stored in a memory.

The term “memory” refers to one or more storage media, such as semiconductor memory, magnetic storage, or optical storage, that store instructions and data to be processed by the processor.

The term “information terminal” refers to any user-operated computing apparatus, such as a smartphone, a tablet device, a personal computer, or a dedicated terminal, that is capable of communicating with the server and presenting information to the user.

The term “user” refers to a human operator who interacts with the information terminal to submit request data and to receive presentation of answer texts.

The term “product identification information” refers to data that uniquely or specifically identifies a product, such as a model number, a product name, a serial code, or a structured identifier assigned to the product.

The term “natural language inquiry” refers to a question or request expressed in a human language, such as a sentence or phrase describing information desired by the user regarding a product.

The term “request data” refers to data transmitted from the information terminal to the server and including at least the product identification information and the natural language inquiry.

The term “information storage device” refers to one or more storage systems, such as databases, file systems, or document repositories, that store document information related to products.

The term “document storage” refers to a logical or physical storage unit within the information storage device that holds document information such as manuals, guides, or frequently asked question entries.

The term “document information” refers to stored information in textual or semi-structured form relating to products, including but not limited to handling information, specification information, and inquiry response information.

The term “handling information” refers to document information describing how to install, configure, operate, maintain, or troubleshoot a product.

The term “inquiry response information” refers to document information written as answers to anticipated or past user questions, including frequently asked questions, support notes, and troubleshooting responses.

The term “related document information” refers to a subset of document information that is retrieved from the information storage device based on the product identification information and that is associated with the product specified in the request data.

The term “document segment” refers to a portion of document information, such as a paragraph, a section, a sentence, or another text unit, that can be individually selected and included in a prompt sentence.

The term “prompt sentence” refers to a text string or text block that is constructed for input to a generative AI model and that includes at least the natural language inquiry and one or more document segments.

The term “generative AI model” refers to a machine-learned model, such as a neural network-based language model, that generates natural language output in response to input text including the prompt sentence.

The term “natural language processing” refers to computational techniques for analyzing, interpreting, and generating human language, including tokenization, encoding, inference, and decoding operations performed by the generative AI model.

The term “answer text” refers to a natural language output generated by the generative AI model based on the prompt sentence, and intended to answer the user's natural language inquiry.

The term “token capacity” refers to a maximum number of text units, such as tokens defined by the generative AI model's tokenizer, that the generative AI model can process for a single input or prompt.

The term “summarize or truncate” refers to processing operations that reduce the length of one or more document segments, by generating shorter representations or by cutting off text beyond a defined limit, so that the prompt sentence fits within the token capacity.

The term “response data” refers to data generated by the server and transmitted to the information terminal, including at least the answer text and optionally additional metadata.

The term “text format” refers to a representation of the answer text as character data suitable for display on the information terminal.

The term “speech-synthesis data format” refers to a representation of the answer text as data suitable for input to a speech synthesis processing unit, including phonetic strings, markup-based speech instructions, or encoded audio signals.

The term “speech synthesis processing unit” refers to a hardware or software component that converts the answer text or speech-synthesis data format into an audio signal for playback.

The term “audio signal” refers to an electrical or digital signal that encodes sound information for reproduction by an output device such as a speaker or headphones.

The term “presentation” refers to the act of making the answer text perceptible to the user, including displaying the text on a screen and/or outputting corresponding audio through a sound output device.

In one embodiment, a server implements the claimed system using a general-purpose computing platform. The server includes at least one processor, a main memory, a non-volatile storage device, a network interface, and an operating system. The server runs a server-side application implemented, for example, in a high-level programming language executing on the operating system. The server connects via the network interface to one or more information terminals and to at least one information storage device that stores document information related to products.

An information terminal operates as a client device and may be realized as a smartphone, a tablet, a notebook computer, or a dedicated terminal. The terminal includes at least one processor, a memory, a display unit, an input unit such as a touch panel or keyboard, an audio output unit such as a speaker or earphones, and optionally a microphone. The terminal executes a web browser or a dedicated native application. The terminal presents a graphical user interface that includes at least a text input field for a natural language inquiry and a field for product identification information, such as a product model number.

A user operates the information terminal and enters product identification information and a natural language inquiry through the interface. The terminal converts the entered information into request data including at least the product identification information and the natural language inquiry. The terminal transmits the request data to the server via a network using a communication protocol such as HTTP over TLS. The terminal then waits for response data from the server and, when the response data is received, the terminal displays an answer text and, when requested by the user, converts the answer text into speech using a text-to-speech engine and outputs the audio through the audio output unit.

The server analyzes the request data and extracts the product identification information and the natural language inquiry. The server accesses an information storage device that can be implemented as one or more relational database management systems, distributed file systems, or document stores. In one example, the server uses a relational database system to store structured metadata and document identifiers, and uses a document store to store the full text of manuals, troubleshooting guides, and frequently asked question entries. The server stores each document as a set of document segments, such as paragraphs or sections, each associated with metadata fields including product identifier, document type, section title, and semantic tags.

The server retrieves related document information by issuing structured queries to the information storage device. The server uses the product identification information as a key to restrict candidate documents to those associated with the specified product. The server then applies additional filtering based on the natural language inquiry. In one implementation, the server computes a relevance score between the inquiry and each document segment. The server represents the inquiry and each document segment as numerical vectors generated by a trained embedding model and then computes similarity metrics, such as cosine similarity, to identify document segments that are most relevant to the inquiry. The server ranks the document segments according to their similarity scores and selects the highest-ranking segments as candidate input for a generative AI model.

The server constructs a prompt sentence using the natural language inquiry and the selected document segments. The server stores the prompt sentence as a text block in memory, composed of an instruction part, a user query part, and a context part containing the document segments. The server may include meta-instructions that guide the generative AI model to use the document context strictly and to avoid hallucinated information. For example, the server may construct a prompt sentence such as:
“You are a customer support assistant that answers questions about product manuals and FAQs.

The user asked: ‘Please tell me the FAQ for product model ABC123, especially about initial setup and common errors.’
Here are relevant manual and FAQ excerpts for model ABC123:
1) Manual: ‘To perform the initial setup, connect the power cable to the device, attach the network cable to the router, and follow the on-screen setup wizard until completion.’
2) FAQ: ‘Q: What does error code E01 mean on model ABC123? A: E01 indicates a network connection issue. Check the router connection and restart the device.’
3) FAQ: ‘Q: How can I reset model ABC123 to factory settings? A: Hold the reset button for about 10 seconds while the device is powered on.’
Based on these documents, provide a concise and accurate FAQ-style answer to the user's question.”

The server limits the size of the prompt sentence according to a token capacity supported by the generative AI model. The server estimates token counts by applying a tokenizer consistent with the generative AI model's vocabulary. If the combined length of the natural language inquiry and the document segments exceeds the token capacity, the server summarizes or truncates lower-priority document segments using predetermined rules. For instance, the server may compress repeated boilerplate text, remove low-relevance segments, or generate shorter summaries of long sections using a separate summarization function, and then reconstruct the prompt sentence with the shortened content. This pre-processing reduces the amount of text processed by the generative AI model and allows the server to maintain responsiveness and throughput even under high load.

The server interfaces with a generative AI model implemented as a trained neural network. In one embodiment, the generative AI model is a transformer-based language model comprising an input embedding layer, a plurality of self-attention layers, feed-forward layers, and an output projection layer. The server sends the prompt sentence to an inference engine that executes the generative AI model on computing hardware such as graphics processing units or tensor processing units. The server supplies model configuration parameters such as maximum output length, temperature, and decoding strategy (for example, greedy decoding or top-k sampling). The inference engine performs tokenization of the prompt sentence, applies the embedding layer to convert tokens into vectors, executes multiple layers of multi-head self-attention and non-linear transformations, and generates output token probabilities at each position. The inference engine selects output tokens according to the decoding strategy and generates the answer text as a sequence of tokens, which is then converted back into a text string.

The server can use additional technical mechanisms to improve accuracy and efficiency. In one embodiment, the server uses a domain-adapted generative AI model that has been fine-tuned on a corpus of product manuals and helpdesk transcripts. During training, the server or another training system minimizes an objective function such as cross-entropy loss between predicted tokens and ground-truth tokens. The training procedure updates model weights by gradient-based optimization, such as stochastic gradient descent or variants like Adam optimization. The training process may include data augmentation techniques such as paraphrasing of questions, sampling of rare error messages, and random masking of context segments to improve robustness. By using a domain-adapted model and by constraining the prompt sentence to high-relevance segments, the server improves the precision of generated answers and reduces the frequency of incorrect or irrelevant responses.

The server uses internal data structures to handle the flow of information from retrieval to generation. The server may represent each document segment as a record in memory, with fields for product identifier, segment text, section type, embedding vector, and relevance score. The server maintains a queue or priority list of candidate segments sorted by relevance score. When constructing the prompt sentence, the server populates a buffer with the natural language inquiry and sequentially appends the highest-ranking segments until an estimated token budget is reached. The server may mark appended segments with identifiers so that the response data can optionally include references or citations in the answer text. This structured data flow enables the server to consistently form compact, information-dense prompt sentences that are tailored to the generative AI model's constraints.

The server constructs response data containing at least the answer text produced by the generative AI model. The server may also include auxiliary fields such as the product identification information, a list of used segment identifiers, and a confidence score computed by analyzing the likelihoods produced by the generative AI model and the relevance scores of the underlying segments. The server transmits the response data to the information terminal over the network. The response data has a compact size compared to the original full document information, because the server has already reduced and focused the content at the server side. This reduces network bandwidth usage and lowers latency between the server and the terminal.

The terminal receives the response data and extracts the answer text for presentation. The terminal displays the answer text on the display unit in a structured format. For example, the terminal may display section headers such as “Initial Setup” and “Common Errors,” along with bullet points summarizing key steps or error explanations. The terminal may provide user interface elements allowing the user to scroll, copy, or save the answer. When the user activates an audio playback control, the terminal supplies the answer text to a text-to-speech engine implementing a speech synthesis processing unit. The text-to-speech engine converts the answer text into an audio signal using acoustic models and vocoder algorithms and outputs the audio signal through the speaker. This dual-mode presentation improves accessibility and allows hands-free usage.

The described configuration improves computer technology beyond simple automation of human work. The server does not merely display existing static documents; instead, the server coordinates document retrieval, vector-based relevance computation, token budget management, and neural inference in a unified pipeline. The server reduces the amount of text given to the generative AI model by selecting only the most relevant segments and by automatically summarizing or truncating content to fit the token capacity. This reduces the computational load on the generative AI model, shortens inference time, and lowers energy consumption on model-serving hardware. The server also reduces the volume of data transmitted to the terminal by returning compact answer texts rather than full documents, which results in reduced communication load and faster response.

The generative AI model processes information in a way that differs from conventional manual or rule-based systems. Instead of performing simple keyword substitution or template filling, the model uses multi-layer attention mechanisms to dynamically weigh contributions from different segments of the prompt sentence. During inference, the model computes attention scores between tokens of the natural language inquiry and tokens of each document segment, allowing the model to focus on contextually important parts of the input. The server's controlled construction of the prompt sentence, combined with this attention mechanism, leads to more accurate and contextually appropriate answers, particularly for complex or multi-step procedures.

The server's use of embedding-based retrieval and token-aware prompt construction is a non-conventional sequence of operations that yields technical effects. Traditional systems might index documents purely by string-based term frequency and then either send large text bodies to a model or to the terminal. In contrast, the server here converts text segments into embeddings, computes similarity scores numerically, and enforces a token budget threshold before calling the generative AI model. This sequence produces a significantly smaller and more relevant context set for the model, which in turn reduces average inference time per query and increases the number of concurrent queries the system can process. The reduction in token count also decreases the probability of context truncation within the model, improving the reliability and completeness of responses.

The server can employ variations of the described embodiment. In one variation, the server uses separate generative AI models for different product categories and selects a model according to the product identification information. In another variation, the server performs on-device caching of relevance scores and document embeddings, so that frequently accessed products require fewer retrieval and embedding computations. The server may also adjust summarization aggressiveness based on measured system load, allocating a smaller token budget during peak usage to maximize concurrency. Each of these variations maintains the core concept of integrated, token-aware retrieval and generation, yet allows adaptation to different deployment conditions.

The terminal can also implement alternative configurations. In one embodiment, the terminal pre-processes the natural language inquiry with a local language understanding model to classify the type of question (for example, installation, error code, maintenance), and supplies this classification label to the server as part of the request data. The server then uses the label to filter document segments further at the retrieval stage. In another embodiment, the terminal logs user selections of parts of the answer text, such as which section the user expanded or which error explanation the user played in audio form, and sends aggregated feedback to the server. The server can use this feedback to adjust future relevance scoring and prompt construction, thereby improving the accuracy and user-perceived quality of generated answers.

The described embodiments demonstrate how the server and the terminal cooperate to implement the claimed system. The server executes specialized data-processing algorithms, including vector-based similarity computation, token-capacity management, and transformer-based neural inference, to transform large, heterogeneous document repositories into concise, context-aware answer texts. The terminal renders these answer texts efficiently in both visual and audio forms. By structuring retrieval and generative processing around the technical constraints and capabilities of the underlying computation hardware and models, the system achieves improved processing speed, reduced resource consumption, and enhanced accuracy compared to conventional systems that rely on simple keyword search or unstructured use of generative models.

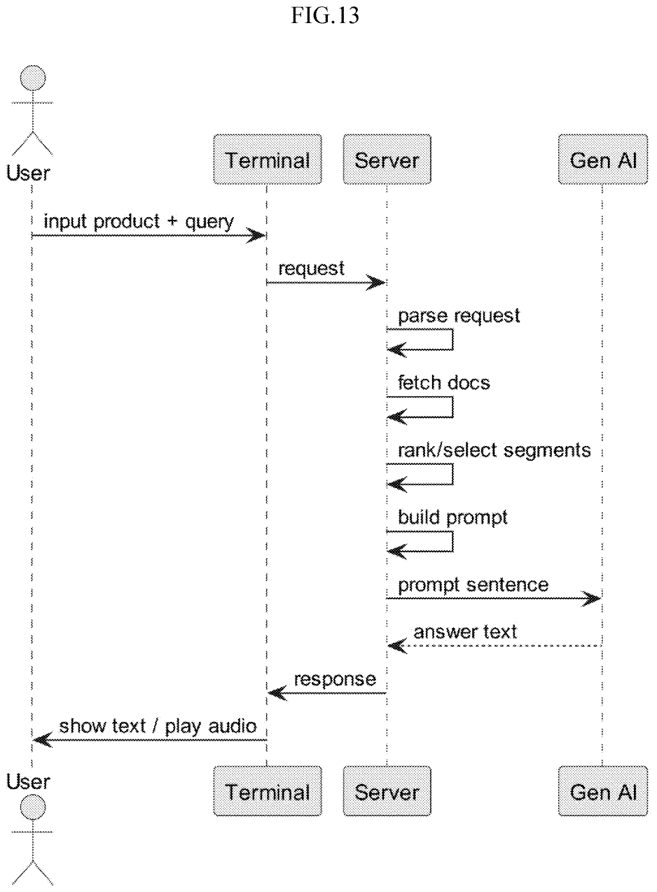

The following describes the processing flow using FIG. 13.

### Step 1

The user operates the terminal and inputs product identification information and a natural language inquiry into an input field displayed on a screen.
The input of Step 1 is raw keystrokes or touch events generated by the user, and the output is structured input data on the terminal containing at least a product identifier string and an inquiry text string. The terminal converts the keystrokes into character data, validates non-emptiness and basic format, and stores the product identifier and inquiry in a local data structure.

### Step 2

The terminal constructs request data and transmits the request data to the server.
The input of Step 2 is the structured input data from Step 1, and the output is a network message sent over a communication link to the server. The terminal serializes the product identifier and inquiry into a message format, attaches headers such as destination address and content type, and sends the message over a secure channel using a communication protocol.

### Step 3

The server receives the request data and parses the contents of the request data.
The input of Step 3 is the network message from the terminal, and the output is extracted request parameters including the product identifier and the inquiry text. The server decapsulates the message from the transport protocol, reads the payload, parses the payload into structured fields, and checks that the product identifier and inquiry text satisfy basic syntactic constraints.

### Step 4

The server retrieves candidate document information from an information storage device based on the product identifier.
The input of Step 4 is the product identifier obtained in Step 3, and the output is a set of document records associated with the identified product. The server constructs and executes a query against a database or document store using the product identifier as a key, and receives from the storage device multiple records that include document segments such as manual sections and frequently asked question entries.

### Step 5

The server computes relevance scores between the inquiry text and each retrieved document segment.
The input of Step 5 is the inquiry text and the set of document records from Step 4, and the output is a list of document segments each annotated with a numerical relevance score. The server converts the inquiry text and each document segment into vector representations using a trained embedding model, computes similarity values such as cosine similarity between the vectors, and stores the similarity values as relevance scores linked to the corresponding segments.

### Step 6

The server selects high-ranking document segments according to the relevance scores.
The input of Step 6 is the list of document segments with associated relevance scores from Step 5, and the output is a subset of document segments filtered and ordered by relevance.
The server sorts the segments by their scores in descending order, applies a threshold or top-k selection rule, and discards segments with low relevance, thereby producing a smaller set of highly relevant segments.

### Step 7

The server estimates token usage for a prospective prompt sentence and adjusts the set of document segments based on a token capacity.
The input of Step 7 is the inquiry text and the subset of relevant document segments from Step 6, and the output is an adjusted subset of document segments that conforms to a token limit. The server applies a tokenizer consistent with the generative AI model to the inquiry text and to each segment to count the number of tokens, sums the token counts, compares the sum to a predetermined token capacity, and, when the sum exceeds the capacity, summarizes or truncates lower-priority segments or removes some segments until the estimated token count falls below the capacity.

### Step 8

The server constructs a prompt sentence for input to the generative AI model.
The input of Step 8 is the inquiry text and the adjusted subset of document segments from Step 7, and the output is a single prompt sentence or prompt text block stored in memory.
The server concatenates an instruction portion, the inquiry text, and the selected segments in a predefined template, inserts delimiters and labels for clarity, and formats the entire content as a continuous text string that can be consumed by the generative AI model.

### Step 9

The server performs an inference call to the generative AI model using the prompt sentence.
The input of Step 9 is the constructed prompt sentence from Step 8, and the output is a raw generated text sequence representing an answer. The server sends the prompt sentence to a model inference engine, which tokenizes the prompt, runs the tokens through a neural network comprising embedding layers, attention layers, and feed-forward layers, computes probability distributions over output tokens, and decodes a sequence of output tokens that are then converted back into text and returned to the server.

### Step 10

The server performs post-processing on the generated answer text and constructs response data.
The input of Step 10 is the raw generated text sequence from Step 9 and the original request parameters from Step 3, and the output is structured response data ready for transmission to the terminal. The server trims extraneous leading or trailing characters, optionally inserts section headings, may add references to underlying document segments, wraps the final answer in a response structure that includes the product identifier and metadata, and prepares the structure for network transmission.

### Step 11

The server transmits the response data to the terminal over the network.
The input of Step 11 is the structured response data from Step 10, and the output is a network message containing the response data delivered to the terminal. The server serializes the response data, attaches appropriate protocol headers, and sends the message via the network interface to the address associated with the terminal.

### Step 12

The terminal receives the response data and extracts the answer text.
The input of Step 12 is the network message sent by the server in Step 11, and the output is the answer text and optional metadata stored in memory on the terminal. The terminal decapsulates the message, parses the payload into structured fields, retrieves the answer text and other fields such as product identifier and confidence indicators, and stores these values in data structures associated with the user interface.

### Step 13

The terminal presents the answer text to the user in textual form.
The input of Step 13 is the answer text from Step 12, and the output is a visual display of the answer text on the terminal's display unit. The terminal formats the text with line breaks and optional headings, renders the text in a display area of the user interface, and updates the screen so that the user can read the generated answer.

### Step 14

The terminal optionally converts the answer text into audio and outputs the audio to the user.
The input of Step 14 is the answer text from Step 12 and a user instruction indicating a request for audio playback, and the output is an audio signal emitted from the terminal's speaker or earphones. The terminal forwards the answer text to a text-to-speech engine, generates an audio waveform or encoded audio stream, and drives the audio output hardware to play the synthesized speech to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional product support systems that rely on static knowledge bases and simple keyword matching suffer from multiple technical limitations in terms of information retrieval, natural language generation, and control of machine-generated content. First, when a user provides only a product identifier or a noisy product image, traditional systems frequently fail to robustly resolve the correct product record, resulting in retrieval of irrelevant document information and degradation of response accuracy. Second, even when appropriate manuals and question-and-answer documents are stored in a repository, existing systems typically pass large, unstructured text blocks directly to a generative model or rule-based engine without constructing a well-scoped prompt or context. This often leads to inefficient use of computing resources, unnecessary token consumption, hallucinated answers that are not grounded in the underlying documents, and inconsistent answer styles.

Third, conventional architectures generally treat a generative AI model as an opaque component and do not apply fine-grained, programmatic control over the prompt sentence, such as encoding explicit constraints, product-specific context, and user-specific style requirements. As a result, the system cannot systematically adapt the content and tone of responses to different user states, and cannot reliably enforce that answers remain within the bounds of trusted product documentation. Fourth, many systems lack an integrated mechanism for dynamically estimating a user's emotional state from multimodal signals, and therefore cannot automatically adjust answer detail level, politeness, and information ordering in a way that improves the effectiveness and usability of the human-machine interaction at the system level.

Fifth, existing systems typically do not incorporate a structured reliability evaluation pipeline that programmatically compares an AI-generated answer against the retrieved document context and product attributes. Without such evaluation, low-quality answers may be delivered to users, and opportunities for routing problematic responses to a human operator for corrective action are missed. Additionally, there is often no standardized process for feeding operator-corrected answers back into a storage device as reusable structured question-and-answer information, which limits the system's ability to improve over time and increases redundant processing by the generative model.

Accordingly, there is a need for a computer-implemented system that (i) robustly identifies a target product from user-provided identifiers or images, (ii) constructs a constrained, context-aware prompt sentence for a generative AI model based on product-specific document context and user queries, (iii) dynamically adjusts the prompt and the generated answer according to a computed emotional state of the user, and (iv) evaluates the reliability of the generated answer and, when necessary, orchestrates human intervention and knowledge-base updates. Such a system should improve the technical operation of information processing components by reducing mis-identification of products, minimizing irrelevant context passed to the generative AI model, lowering hallucination rates, and enabling more efficient reuse of corrected answers in subsequent processing.

The specific processing by the specific processing unit 290 of the data processing device 12 in Application Example 2 is realized by the following means.

The present invention provides a server comprising a processor configured to receive, from an information terminal, product identification information or a product image provided by a user and to extract, from such input, product identification information for specifying a target product; to search a storage device that stores product-related document information based on the extracted product identification information and to generate document context by extracting, from document information including handling information and question-and-answer information corresponding to the target product, a document portion related to a question content of the user; to construct, based on the document context and the question content of the user, a prompt sentence for input to a generative AI model, the prompt sentence including at least target product information, the document context, and constraint conditions regarding an expression style of an answer, and to instruct the generative AI model to execute answer generation processing by using the prompt sentence; to obtain a natural language response sentence output by the generative AI model based on the prompt sentence and to convert the response sentence into an information format capable of being provided to the user; to analyze at least one of voice information, image information, and character information acquired from the user to estimate an emotional state of the user and to change instruction content regarding a detail level, politeness, and information presentation order of the answer included in the prompt sentence in accordance with the emotional state; and to calculate a reliability index for the response sentence based on consistency between the response sentence and the document context and a degree of match between the response sentence and attribute information relating to the target product, to output the response sentence and the document context to an operation terminal to permit human confirmation or correction when the reliability index is less than a predetermined threshold, and to store, in the storage device as question-and-answer information associated with the target product, a response sentence after the human confirmation or correction. This enables the server to technically improve the end-to-end support pipeline by programmatically constraining and grounding generative AI output in product-specific documentation, adaptively tailoring prompt sentences and responses based on a computed emotional state of the user, and enforcing a reliability-driven feedback loop with human operators and a structured storage device, thereby reducing erroneous responses, decreasing unnecessary processing by the generative AI model, and enhancing overall efficiency and robustness of the computer-implemented product information provision process.

The term “system” refers to an arrangement including at least one server-side device and one or more information terminals that cooperate via a communication network to execute the processing described in the claims.

The term “processor” refers to one or more hardware information processing elements, such as a central processing unit or a hardware logic circuit, configured to execute instructions implementing the claimed functions.

The term “information terminal” refers to an electronic apparatus operated by a user, such as a mobile communication device, a portable computing device, or a stationary computing device, that is capable of inputting information, displaying information, capturing images, and communicating with the system.

The term “user” refers to an individual or an organization that operates the information terminal to request product-related information or support from the system.

The term “product identification information” refers to character data, numeric data, or symbol data that can be used to specify a product, including but not limited to model numbers, product names, serial identifiers, or codes printed on or associated with the product.

The term “product image” refers to image data acquired by an image capturing component of the information terminal, the image data depicting at least a part of a product, including identifiers, labels, or external features of the product.

The term “target product” refers to a particular product that is identified by the processor based on product identification information or a product image and for which the system is to generate an answer to a user's question.

The term “product-related document information” refers to structured or unstructured digital content stored in a storage device, including manuals, handling guides, specifications, troubleshooting documents, and question-and-answer documents concerning one or more products.

The term “storage device” refers to a hardware storage unit or a combination of hardware storage units, such as a magnetic storage apparatus, a semiconductor memory apparatus, or a distributed storage system, used to store product-related document information, question-and-answer information, and associated metadata.

The term “handling information” refers to document content describing operation methods, installation methods, maintenance procedures, safety instructions, or usage conditions of a product.

The term “question-and-answer information” refers to document content in which frequently asked questions or typical user inquiries regarding a product are associated with corresponding answer texts.

The term “document context” refers to a text segment or a group of text segments extracted by the processor from product-related document information that is determined to be relevant to a particular user question.

The term “question content of the user” refers to information expressing an inquiry from the user regarding a product, including at least a natural language string that specifies a problem, a request for operation instructions, or a request for product information.

The term “prompt sentence” refers to a control text constructed by the processor for input to a generative AI model, the control text including at least target product information, document context, and constraints on answer expression style, and serving as an instruction for answer generation.

The term “generative AI model” refers to an artificial intelligence model that performs natural language generation based on input text, the model being capable of outputting a response sentence by learning statistical or neural relationships between input sequences and output sequences.

The term “answer generation processing” refers to computational processing performed by the generative AI model in response to the prompt sentence in order to produce a natural language response sentence corresponding to the user's question.

The term “natural language response sentence” refers to output text generated by the generative AI model in a human language, the text being intended to answer the user's question about the target product.

The term “information format capable of being provided to the user” refers to a representation of the response sentence suitable for presentation via the information terminal, including text, structured text, or audio data obtained by converting text to speech.

The term “voice information” refers to audio data that contains speech produced by the user and captured by an audio input component of the information terminal.

The term “image information” refers to visual data that contains images or video frames depicting at least the user's face, body, or surroundings, captured by an imaging component of the information terminal.

The term “character information” refers to text data input by the user via an input interface of the information terminal, including typed sentences or selected text elements.

The term “emotional state” refers to an internal state of the user, such as frustration, satisfaction, calmness, or urgency, that is estimated by the processor based on analysis of at least one of voice information, image information, and character information.

The term “detail level of the answer” refers to a degree of granularity of explanation included in the response sentence, including the amount of step-by-step instructions, background information, or supplemental details.

The term “politeness” refers to a style attribute of the response sentence that determines a degree of courteous or formal expressions, apologies, and respectful wording appropriate to the user's emotional state.

The term “information presentation order” refers to an arrangement sequence of different pieces of information within the response sentence, such as ordering of main solutions, warnings, and supplementary explanations.

The term “expression style of an answer” refers to qualitative characteristics of the response sentence, including tone, politeness, sentence length, level of technicality, and ordering of content elements.

The term “attribute information relating to the target product” refers to structured data items associated with the target product, including specifications, supported functions, valid ranges, and product category information stored in the storage device.

The term “reliability index” refers to a numerical or categorical measure calculated by the processor that indicates a degree of trustworthiness of the response sentence, based on comparisons with document context and attribute information relating to the target product.

The term “predetermined threshold” refers to a reference value or condition set in advance for the reliability index, used by the processor to decide whether automatic delivery of the response sentence is permitted or whether human confirmation or correction is required.

The term “operation terminal” refers to an electronic apparatus used by a human operator to review, correct, or approve a response sentence and corresponding document context that have been output by the processor.

The term “human confirmation or correction” refers to an operation in which a human operator evaluates the content of the response sentence and optionally edits, supplements, or replaces the response sentence to ensure correctness and appropriateness.

The term “question-and-answer information associated with the target product” refers to structured data stored in the storage device, in which at least one user question pattern regarding the target product is associated with a corresponding, confirmed answer sentence.

In one embodiment, a server cooperates with one or more terminals operated by a user to implement the claimed system. The server includes at least one processor, a main memory, a non-volatile storage device, and a network interface. The terminal includes at least a processor, a display, a user input interface, an image-capturing component such as a camera, a microphone, and a network interface. The server and the terminal communicate over a communication network such as the Internet using a transport protocol such as TCP/IP and an application protocol such as HTTPS.

The server executes control software including a web application layer, an application logic layer, a document management module, a prompt construction module, a generative AI interface module, an emotion estimation module, and a reliability evaluation module. The server also accesses a storage device that holds product-related document information, question-and-answer information, product attribute data, user profiles, and interaction logs. The storage device may include a relational database management system implemented by generic database software and an object storage system implemented by generic storage software.

The terminal executes a client application, such as a native mobile application or a browser-based application, that provides user interfaces for inputting product identification information, capturing product images, inputting questions, and presenting responses in text or audio. The terminal uses the camera to obtain a product image and the microphone to obtain voice information of the user. The terminal packages such data into structured requests and transmits the requests to the server.

The server receives product identification information, such as a model number string, from the terminal or receives a product image captured by the terminal. The server uses an image analysis module implemented by image processing libraries such as a convolutional neural network framework (for example, a generic deep learning framework) and an optical character recognition engine (for example, a generic OCR engine) to detect product labels and text regions in the product image. The server applies convolutional filters, pooling operations, and non-linear activations to feature maps generated from the image, then applies a classifier layer to produce label scores and bounding boxes. The server further uses sequence decoding and character recognition models to convert detected text regions into character strings.

The server extracts one or more candidate product identification strings from the recognized text using pattern matching and heuristic rules that prefer strings matching predefined formats of model numbers or SKU codes. The server compares these candidate strings to entries in a product table of the storage device via indexed queries. The server selects a target product identifier with a highest matching score, thereby specifying a target product even from incomplete or noisy inputs. This image-based resolution of product identity improves robustness over conventional systems that require exact text input.

The server accesses product-related document information by querying the storage device using the target product identifier as a key. The server loads one or more manuals, handling guides, and question-and-answer documents associated with the target product. The server uses a document preprocessing pipeline that converts documents from formats such as PDF or HTML into plain text using a document parsing library, normalizes the text with tokenization, stop-word removal, and sentence segmentation, and stores the normalized text in a searchable index. The server may use an inverted index structure where each term is associated with postings lists containing document identifiers and term positions, thereby enabling efficient retrieval of relevant passages.

The server analyzes the user's question text, provided via the terminal, using a natural language processing library. The server performs tokenization, part-of-speech tagging, and lemmatization, and may apply a semantic embedding model such as a transformer-based encoder to represent the question as a dense vector. The server computes similarity between the question vector and sentence or paragraph vectors of the product documents stored in the index, for example using cosine similarity. The server selects a set of document segments with similarity scores above a threshold as a document context relevant to the user's question.

The server then constructs a prompt sentence to control a generative AI model. The server configures the generative AI model as a neural network with multiple attention layers, feed-forward layers, and layer normalization, trained by a language modeling objective over large corpora of text. During training, the model uses a loss function such as cross-entropy between predicted token distributions and reference tokens, and optimizes the parameters by gradient descent with an optimizer such as Adam. The generative AI model thus encodes statistical relationships between tokens and can perform context-dependent text generation.

The server assembles the prompt sentence by concatenating distinct segments. A first segment defines the role and constraints of the generative AI model, such as:
“You are a technical support assistant for consumer products. Answer only based on the provided product documentation. If information is missing, state that clearly and do not invent details.”

A second segment provides product information and document context, such as:
“Product: Model XYZ123 Smartphone. Relevant manual and FAQ excerpts:
1. ‘The battery lasts up to 12 hours of continuous use.’
2. ‘To replace the battery, first power off the device and remove the back cover.’”

A third segment encodes style constraints based on technical conditions and the estimated emotional state of the user, such as:
“The user is very frustrated and in a hurry. Start with a brief apology, then provide a short, step-by-step answer. Use simple, direct sentences and avoid unnecessary background.”

A fourth segment states the user's question and the final instruction, such as:
“User question: ‘How can I replace the battery?’
Answer the user's question in English. If there are safety warnings, include them at the beginning.”

The server constructs this prompt sentence programmatically using a data structure that includes fields for role specification, product identifier, context segments, style constraints, and user question. The server enforces a token limit for the prompt by truncating or re-ranking context segments based on similarity scores, such that the prompt fits within the input capacity of the generative AI model. This structured construction of the prompt sentence reduces irrelevant context and minimizes hallucination, thereby improving answer accuracy and computational efficiency.

The server transmits the prompt sentence to the generative AI model. The server may implement the generative AI model locally or connect to a remote model host via an inference API. The server sets model parameters such as temperature, maximum output length, and decoding strategy (for example, greedy decoding or beam search). The generative AI model performs attention computations across all tokens of the prompt sentence, computing attention scores using a scaled dot-product and aggregating value vectors to form contextualized representations at each layer. The output layer produces a probability distribution over the vocabulary for each step, and the server selects tokens sequentially to form a natural language response sentence.

The server performs post-processing on the response sentence, such as normalizing whitespace, formatting bullet lists, and ensuring that numerical values are consistent with the document context through explicit checks. The server, for example, compares any duration or capacity values mentioned in the response sentence against attribute information stored for the target product. If discrepancies are detected, the server re-weights candidate responses or flags the answer as potentially unreliable.

The server further analyzes the user's emotional state by processing input signals received from the terminal. The terminal captures voice information and, optionally, image information such as a facial image of the user. The server uses a feature extraction module to compute acoustic features (such as pitch, energy, and speaking rate) from voice information and visual features (such as facial muscle activity and gaze direction) from image information. The server feeds these features into a separate neural network classifier trained for emotion recognition. This classifier may use a recurrent or transformer-based architecture and is trained with labeled emotion data using a supervised learning objective that minimizes a classification loss function.

The server combines emotion predictions from voice and image modalities with sentiment analysis results derived from character information of the user's question. The server uses a weighted fusion rule to compute an emotional state vector, which represents degrees of frustration, satisfaction, urgency, and calmness. The server then decides style parameters for the response, such as detail level, politeness, and ordering of information, based on predefined mappings from emotional state ranges to style configurations. By encoding these style parameters explicitly in the prompt sentence, the server controls the generative AI model at the prompt level rather than post-editing long responses, which reduces iterative corrections and latency.

The server also computes a reliability index for each generated response sentence. The server encodes both the response sentence and the document context segments using a semantic encoder network and measures pairwise similarities between corresponding claims and supporting text. The server additionally checks that specific product attributes, such as maximum voltage, supported accessory types, or warranty periods, match values in a structured product attribute table. The server aggregates these measures into a numerical reliability index using a function such as a weighted sum or a small neural scoring network trained to distinguish high-quality and low-quality answers based on past operator evaluations. By doing so, the server implements a concrete, algorithmic reliability evaluation rather than a simple heuristic or manual check.

When the reliability index is above a predetermined threshold, the server treats the response sentence as sufficient and returns it directly to the terminal after formatting. When the reliability index is below the threshold, the server generates a data packet containing the response sentence, the prompt sentence, the document context, and the computed reliability index, and transmits this packet to an operation terminal used by a human operator. The operator reads the proposed response and may modify or replace it. The operation terminal then returns the corrected response sentence to the server.

The server stores the corrected response sentence in the storage device as question-and-answer information associated with the target product. The server may store a normalized version of the question, for example converted into a canonical representation with extracted key entities and intents, along with the corrected answer. In future interactions, the server can detect that a new user's question matches an existing entry with high similarity, and can directly retrieve the stored answer without fully invoking the generative AI model or can use the stored answer as a high-priority context segment in a new prompt sentence. This feedback mechanism reduces repeated computation and improves response consistency.

The terminal presents the final response to the user. When the response is text only, the terminal renders the text in a structured layout, emphasizing critical steps. When the user prefers audio, the server converts the response sentence into audio data using a text-to-speech engine. The server controls the text-to-speech engine with parameters such as speaking rate, intonation, and voice type and then transmits the resulting audio file to the terminal. The terminal plays the audio via the speaker, enabling hands-free consumption. This coordinated control of different hardware components, such as the camera, microphone, display, and speaker of the terminal, ties the abstract processing to concrete machine operations.

By configuring the server to construct structured prompt sentences, to dynamically adjust style instructions based on emotion estimation, to perform algorithmic reliability evaluation, and to integrate corrected responses into a persistent knowledge structure, the invention improves fundamental aspects of computer technology. The server reduces unnecessary data transmission by selecting only relevant document segments, thereby lowering network and memory load. The server reduces processing time by avoiding redundant calls to the generative AI model when a highly similar question has been previously answered and stored. The server lowers hallucination rates by forcing the generative AI model to ground responses in explicitly provided context and by algorithmically verifying consistency with attribute data. These improvements are realized by specific data structures (such as segmented prompt fields, inverted document index, emotion state vectors, and reliability scores) and processing flows that are not inherent in generic business processes.

In a variation, the server deploys the generative AI model on a specialized accelerator such as a graphics processing unit or tensor processing unit and uses mixed-precision arithmetic for inference, which reduces energy consumption and increases throughput. The server further compresses document context with sentence-level embeddings and stores them in a vector index to accelerate similarity search. In another variation, the server adaptively adjusts the maximum output length and decoding strategy based on historical interaction statistics for a given product type, which reduces unnecessary tokens and shortens response latency.

In still another embodiment, the server uses a rule-based filter prior to invoking the generative AI model. For example, when the user's question exactly matches a previously stored pattern, the server retrieves the associated answer without constructing a new prompt sentence. When the question partially matches a stored pattern, the server constructs a prompt sentence that includes the stored answer as a candidate and instructs the generative AI model to revise or localize the answer. This combination of rule-based and neural processing provides a non-conventional processing pipeline that goes beyond mere automation of human reasoning and achieves superior technical performance in terms of accuracy, response time, and resource usage.

Through these embodiments and variations, the server, the terminal, and the user cooperate in a concrete technical framework that uses a generative AI model and a carefully constructed prompt sentence not only to automate content generation but also to improve how the computing system identifies products, retrieves and structures document context, controls generation behavior, evaluates reliability, and manages stored knowledge.

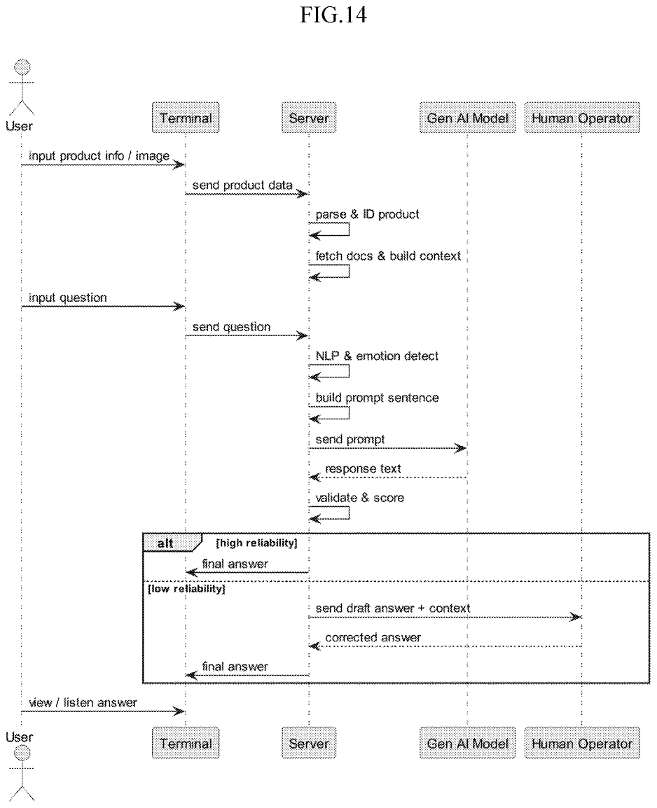

The following describes the processing flow using FIG. 14.

### Step 1

User operates the terminal to provide product information.
User launches an application on the terminal and either types product identification information (for example, a model number or product name) or captures a product image using the terminal camera.
Input: Raw user input (text string and/or image data).
Output: Structured request data on the terminal containing product identification information and/or a product image.
Terminal converts the user input into a request object, attaches metadata such as timestamp, language, and session identifier, and prepares the data for transmission.

### Step 2

Terminal transmits product information to the server.
Terminal establishes a secure communication channel (for example, HTTPS) and sends the structured request containing the product identification information and/or the product image to the server.

Input: Structured request data on the terminal.
Output: Network message received by the server.
Terminal serializes the request into a transmission format (for example, JSON over HTTP) and uses a network interface to send the request to a designated server endpoint.

### Step 3

Server parses the request and normalizes product identification input.
Server receives the network message, parses the message header and body, and extracts text-based product identification information and, when present, image data.
Input: Network message containing product identification text and/or image data.
Output: Normalized internal representation of product identification information and associated image tensor.
Server decodes the JSON payload, converts textual product identifiers into standardized form (for example, uppercase, stripped of whitespace), and converts the image data into a numerical tensor suitable for further processing in image analysis modules.

### Step 4

Server executes image-based product identification when an image is present.
Server applies an image recognition pipeline to the product image to extract candidate model numbers and visual features.
Input: Image tensor representing the product image.
Output: One or more candidate product identification strings with associated confidence scores.
Server feeds the image tensor into a convolutional neural network to compute feature maps, detects regions containing text or labels, uses an OCR engine to convert those regions into character strings, and then applies regular expressions and heuristic scoring rules to filter and rank strings likely to represent product model numbers.

### Step 5

Server resolves the target product using combined text and image information.
Server merges user-entered text identifiers and image-derived candidate identifiers to select a single target product.
Input: Normalized text identifier (if available) and list of candidate identifiers with confidence scores.
Output: Target product identifier selected for subsequent processing.
Server queries a product index in a storage device using each candidate identifier, evaluates match quality by checking existence and similarity of names and categories, computes a combined score for each candidate, and selects the product identifier with the highest score as the target product.

### Step 6

Server retrieves product-related document information from the storage device.
Server accesses manuals, handling guides, and question-and-answer documents corresponding to the target product.
Input: Target product identifier.
Output: A collection of raw documents (for example, PDF, HTML, or text files) associated with the target product.
Server executes database queries using the product identifier as a key, obtains file paths or document identifiers from relational tables, and loads the documents from object storage or file systems into memory as binary data.

### Step 7

Server preprocesses documents and builds searchable text context.
Server converts raw documents into normalized text segments and indexes them for efficient retrieval.
Input: Raw document data for the target product.
Output: Tokenized and segmented text units stored in an internal index, such as paragraphs or sentences with identifiers.
Server invokes document parsers to extract text from PDF or HTML, performs tokenization and sentence segmentation, removes or normalizes markup, assigns identifiers to each text unit, and stores the indexed units in an inverted index or vector index structure for later similarity search.

### Step 8

User provides a question regarding the target product via the terminal.
User types a natural language question (for example, “How can I replace the battery?”) or speaks the question into the terminal microphone, which is converted to text by a speech-to-text process on the terminal or server.
Input: User's question in raw form (typed text or voice audio).
Output: Question text transmitted from the terminal to the server.
Terminal gathers the question, associates it with the existing session and target product identifier, converts any voice input into text, and sends the question text and context identifiers to the server over the network.

### Step 9

Server extracts key terms and semantic representation of the question.
Server processes the question text to obtain both symbolic and vector representations.
Input: Question text from the user.
Output: Set of key terms and a semantic embedding of the question.
Server applies tokenization, lemmatization, and part-of-speech tagging to extract important terms, and then feeds the token sequence into an encoder model (for example, a transformer-based encoder) to compute a dense vector embedding that captures the semantics of the question.

### Step 10

Server retrieves relevant document segments as document context.
Server selects those document text units most relevant to the question based on similarity measures.
Input: Question embedding, key terms, and indexed document text units.
Output: A ranked list of document segments that form the document context.
Server runs keyword search on the inverted index to filter candidates, encodes candidate segments into embeddings, computes similarity scores such as cosine similarity between the question embedding and segment embeddings, ranks segments by score, and selects top-ranked segments within a token budget to compose the document context.

### Step 11

Server estimates the user's emotional state from multimodal input.
Server analyzes at least one of voice information, image information, and character information to infer how the user feels.
Input: User's voice features, facial image features, and question text.
Output: An emotional state vector representing degrees of frustration, satisfaction, urgency, and calmness.
Server extracts acoustic features from voice data, extracts facial expression features from image data using a trained classifier, runs sentiment analysis on the question text, and combines these signals using a weighted function or neural fusion network to produce an emotional state vector.

### Step 12

Server determines answer style parameters based on the emotional state.
Server maps the emotional state vector to specific style parameters, including detail level, politeness, and ordering of information.
Input: Emotional state vector.
Output: Style configuration containing explicit numeric or categorical values for answer length, politeness level, and information ordering priority.
Server evaluates the emotional state against predefined thresholds (for example, high frustration and high urgency), selects appropriate style rules (for example, “high politeness, low detail, solution-first ordering”), and encodes these rules into a structured style configuration object.

### Step 13

Server constructs a structured prompt sentence for the generative AI model.
Server assembles a control text that includes role instructions, product information, document context, user question, and style constraints.
Input: Target product identifier, document context, question text, and style configuration.
Output: Prompt sentence text ready for input to the generative AI model.
Server concatenates a role instruction segment, a segment containing product name and model, a segment listing the selected document context, a segment describing style constraints derived from the emotional state, and a segment containing the user's question and explicit instructions. Server ensures that the total length stays within a maximum token limit by trimming or re-ranking context segments, producing a compact and focused prompt sentence.

### Step 14

Server submits the prompt sentence to the generative AI model and obtains a response.
Server sends the constructed prompt sentence to a neural generative model and receives a natural language answer.
Input: Prompt sentence text.
Output: Natural language response sentence generated by the model.
Server provides the prompt as model input, sets generation parameters such as temperature and maximum token count, allows the model to perform attention-based token prediction across transformer layers, and decodes the resulting token sequence into a response sentence string.

### Step 15

Server validates and formats the generated response sentence.
Server checks the generated response for basic correctness, formatting, and consistency with known product attributes.
Input: Raw response sentence from the generative AI model and product attribute data.
Output: Formatted response sentence and initial validation flags.
Server scans the response for key numerical values or product specifications, compares those values to the attribute table for the target product, sets flags if inconsistencies are detected, and formats the text with clear steps and headings according to internal templates.

### Step 16

Server computes a reliability index for the response sentence.
Server algorithmically measures how well the response sentence aligns with the document context and product attributes.
Input: Response sentence, document context segments, and product attribute data.
Output: Reliability index value representing trustworthiness of the response.
Server encodes the response sentence and each context segment into semantic embeddings, computes similarity scores, aggregates these scores with attribute consistency checks into a numeric value using a scoring function or small neural network, and outputs the resulting reliability index.

### Step 17

Server decides whether to deliver the response directly or request human intervention.
Server compares the reliability index with a predetermined threshold and branches processing accordingly.
Input: Reliability index and formatted response sentence.
Output: Decision flag and, optionally, a review package for an operator.
Server checks if the reliability index is greater than or equal to the threshold; if so, server marks the response as auto-approved. If the index is below the threshold, server builds a review package that includes the response sentence, the prompt sentence, the document context, and the reliability index, and directs this package to an operation terminal for human review.

### Step 18

Human operator reviews and, if necessary, corrects the response sentence.
User (operator) at the operation terminal examines the generated response and makes adjustments when low reliability is indicated.
Input: Review package containing the response sentence, prompt sentence, document context, and reliability index.
Output: Operator-confirmed or operator-corrected response sentence returned to the server.
User reads the response and source context, edits incorrect portions, adds missing steps or warnings, or entirely rewrites the answer, then submits the corrected answer back to the server through the operation terminal.

### Step 19

Server stores the final response as reusable question-and-answer information.
Server records the final version of the response associated with the target product and the corresponding question pattern.
Input: Final response sentence (auto-approved or operator-corrected), question text, and target product identifier.
Output: New or updated question-and-answer record stored in the storage device.
Server normalizes the question, links it with the final answer and product identifier, inserts or updates a record in a question-and-answer table, and optionally computes and stores a vector representation of the question for future similarity search.

### Step 20

Server converts the final response into a user-presentable format and transmits it to the terminal.
Server prepares text and, optionally, audio output based on user preferences.
Input: Final response sentence and user preference settings.
Output: Response payload containing formatted text and/or audio data sent to the terminal.
Server formats the text for display, and if audio output is required, calls a text-to-speech engine to generate audio data. Server then bundles the text and audio references in a response object and sends this object to the terminal via the network.

### Step 21

Terminal presents the response to the user.
Terminal displays the answer text and, if available, plays the audio so that the user can understand the product information.
Input: Response payload containing formatted text and/or audio data.
Output: Visual and/or auditory presentation of the answer to the user.
Terminal renders the text in a user interface component, highlights important steps, provides controls for playing or pausing audio, and updates interface elements such as status indicators to show that a new answer has been received and processed.

### Step 22

User optionally provides feedback or follow-up questions.
User reads or listens to the response and may react by providing feedback or asking additional questions.
Input: Presented answer and user's subjective evaluation of correctness and usefulness.
Output: New question or feedback data transmitted from the terminal to the server.
User indicates satisfaction or dissatisfaction through UI elements, or enters a follow-up question (for example, “That did not solve my issue; what else can I try?”). Terminal captures this information and sends it to the server, which then restarts the processing sequence from the question analysis stage using the stored product and interaction context.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

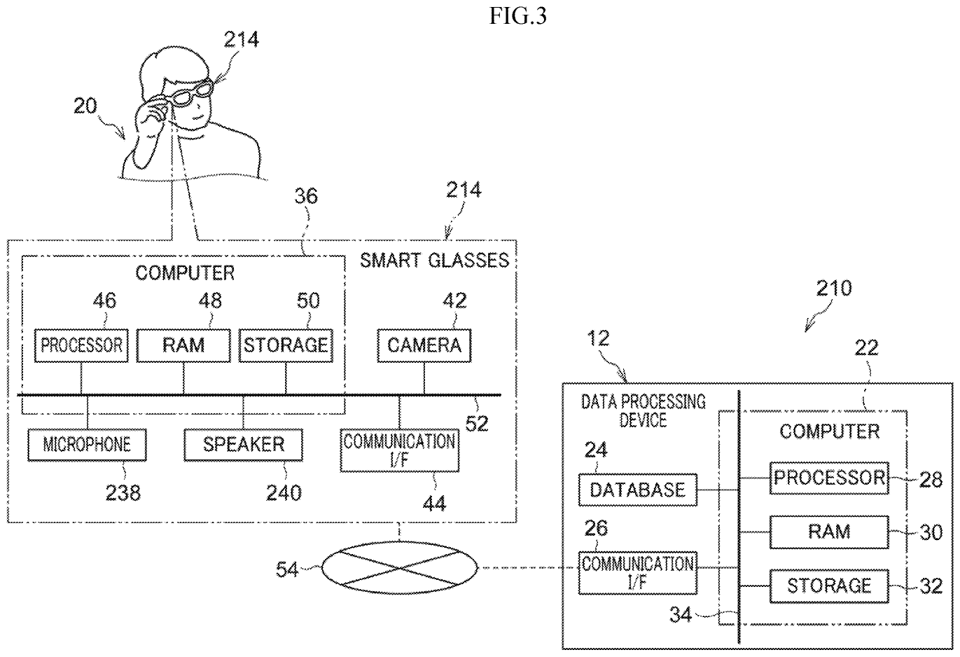

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

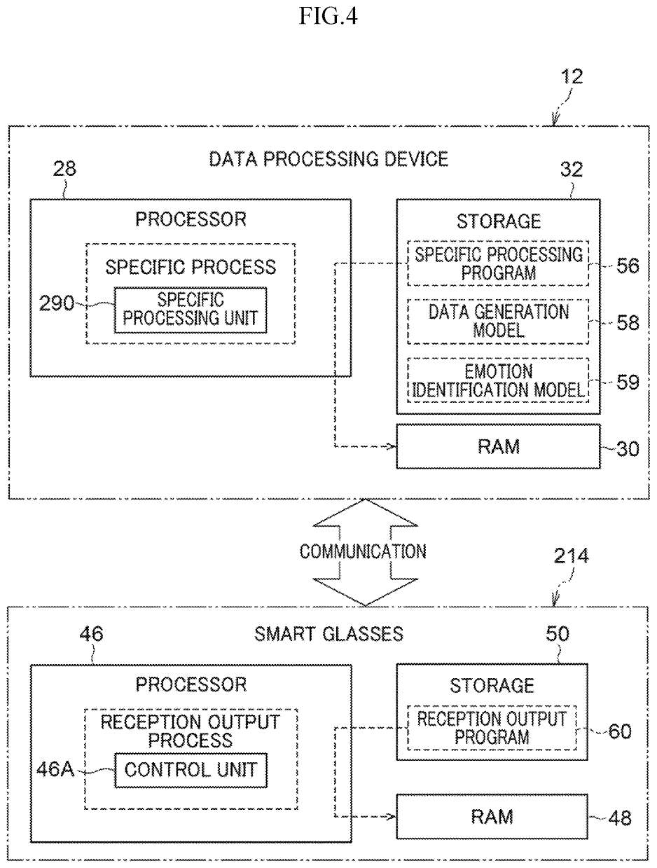

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

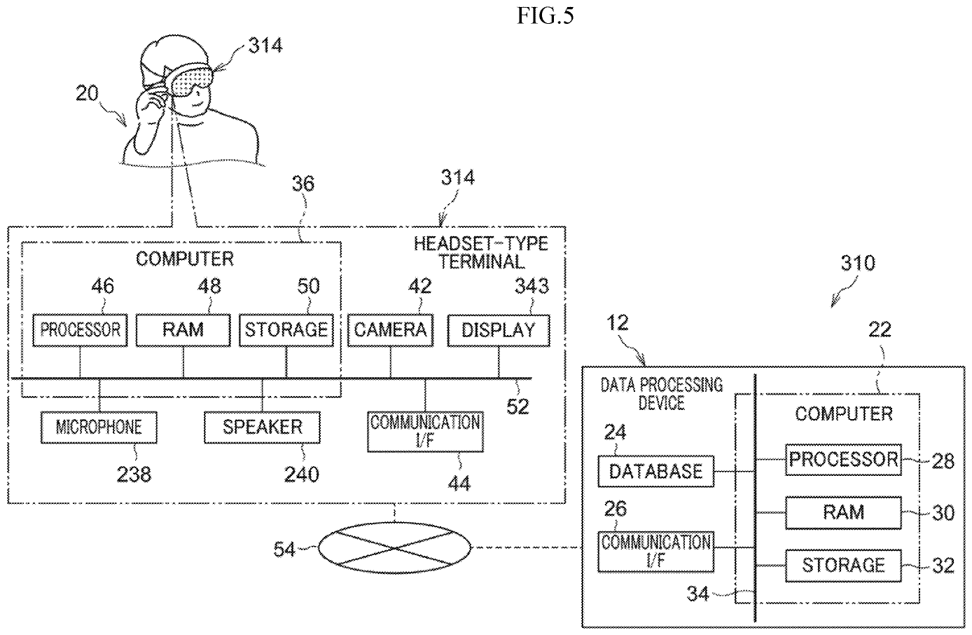

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

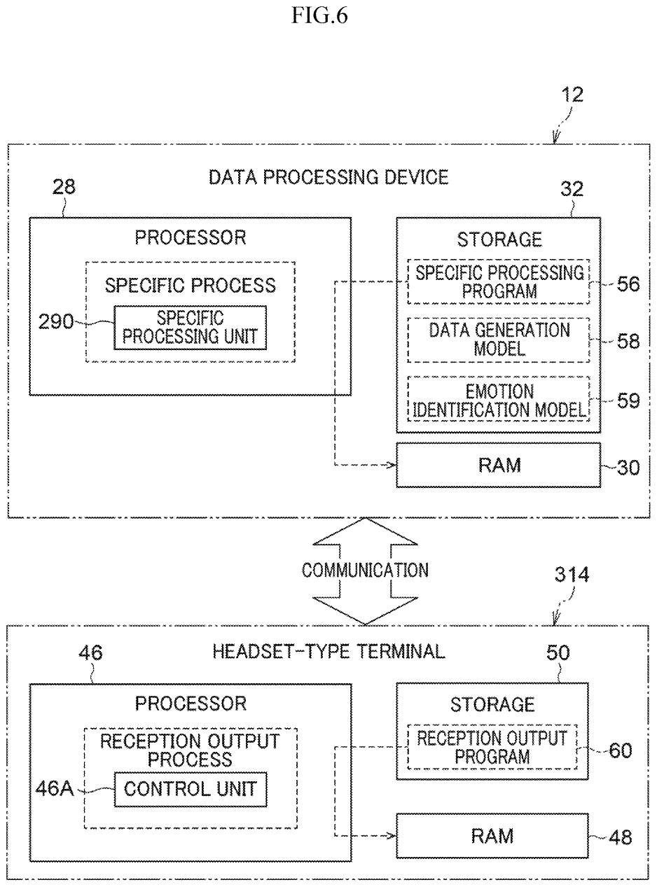

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

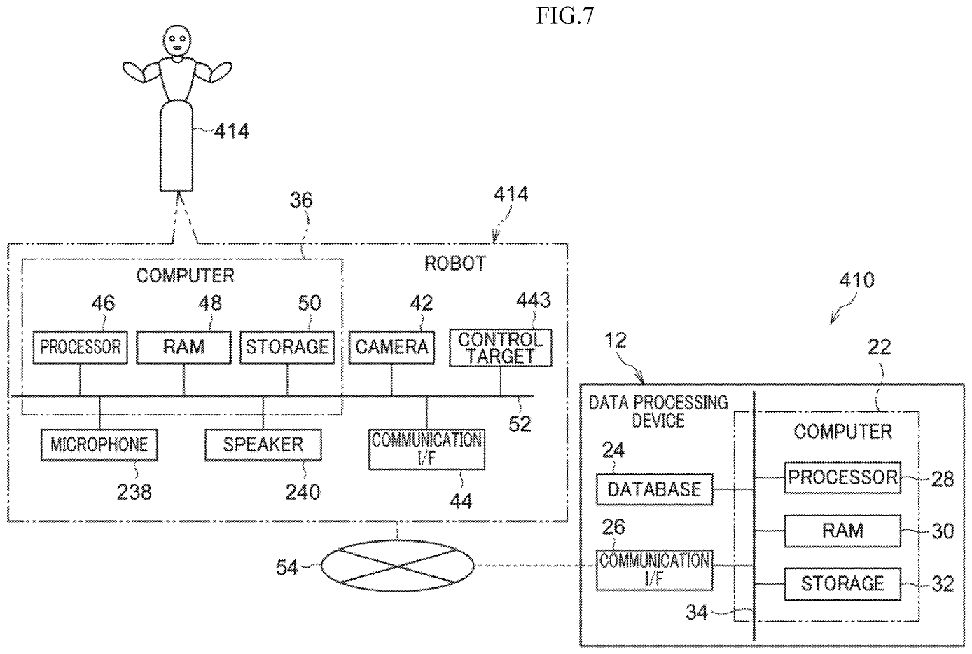

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

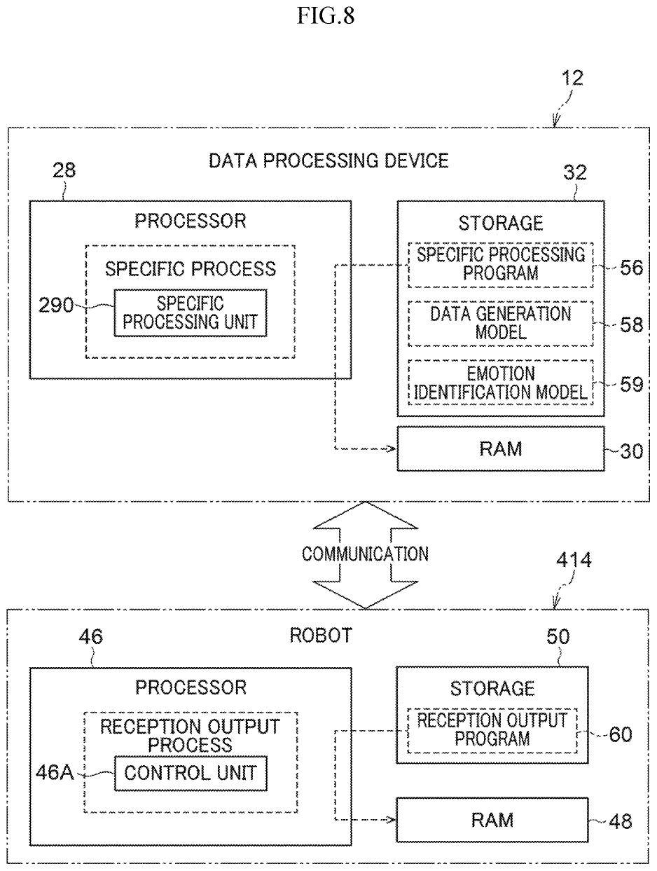

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

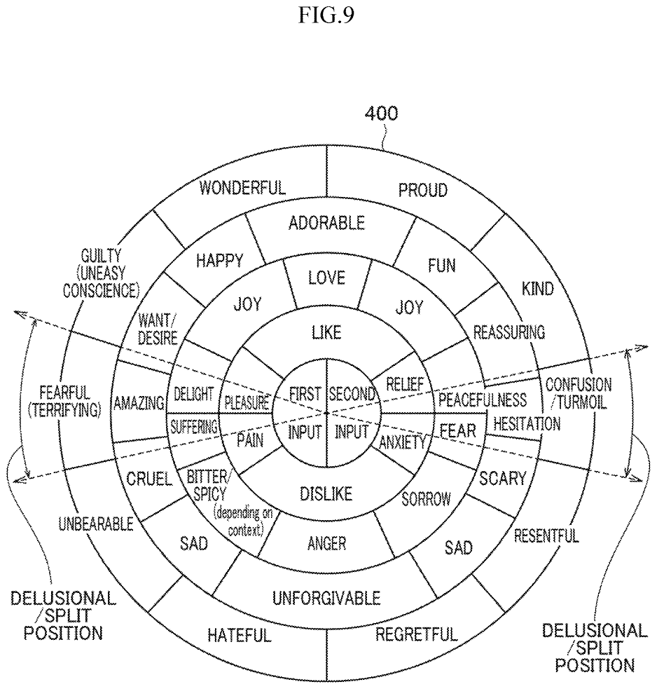

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

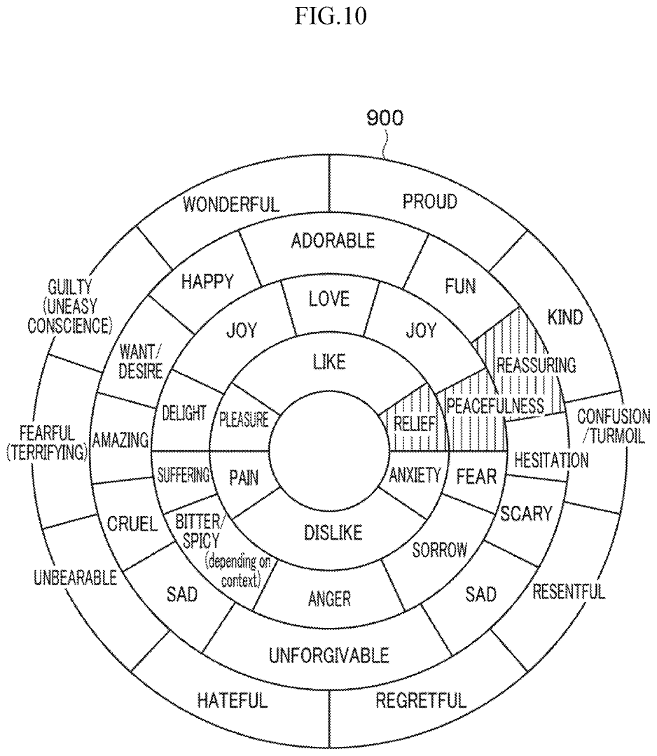

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire, from a user terminal via a communication network, image data including a product, and execute image analysis processing using image processing software and machine learning software to extract character information and pattern information from the image data and obtain identification information and feature information of the product, and normalize and integrate product identification information based on the identification information and the feature information, and retrieve document information associated with a target product by performing a matching process between the product identification information and product information stored in an information storage apparatus using a query language, and
extract, from the document information, information related to a natural language inquiry from a user, and generate a prompt sentence to be input to a generative AI model by constructing a prompt including the related information and the inquiry, and
transmit the prompt to the generative AI model, obtain answer text regarding the target product from the generative AI model, and generate response data for presentation to the user by performing predetermined formatting processing and content verification processing on the obtained answer text, and
transmit the response data to the user terminal as text data and, when necessary, convert the response data into audio data using speech synthesis software and transmit the audio data to the user terminal.

### Supplementary 2

The system according to supplementary 1,
wherein the processor is configured to
perform analysis processing to estimate an emotional state of the user based on audio data, image data, and text data acquired from the user terminal, and adjust content and format of the answer by changing a description style of the prompt and an expression style of the response data in accordance with the emotional state.

### Supplementary 3

The system according to supplementary 1,
wherein the processor is configured to
perform reliability evaluation processing on the answer text obtained from the generative AI model, and, when reliability is determined to be less than a predetermined threshold, present the prompt and the answer text to a human response support apparatus and reflect supplementary information or correction information from the response support apparatus in the response data.

### Application Example 1

### Supplementary 1

A system comprising a processor,
wherein the processor is configured to
analyze image data including a product, the image data being acquired from an information processing terminal operated by a user, by using image processing technology, and extract product identification information and product attribute information from the image data, search, based on the extracted product identification information and the product attribute information, an information storage device storing document data relating to products, and identify document information corresponding to a target product from the document data, construct, based on the identified document information relating to the target product and inquiry information acquired from the user, a prompt sentence to be input to a generative information processing model, supply input data including the prompt sentence to the generative information processing model, and cause the generative information processing model to generate answer information in a natural language,
output, based on the generated answer information, explanation information relating to the target product as visual information to the information processing terminal, convert the answer information into audio data by using speech synthesis technology, and output the audio data to the information processing terminal, and
cause, by control information transmitted to the information processing terminal, the information processing terminal to display the visual information on a display device and to reproduce the audio data from an acoustic output device.

### Supplementary 2

The system according to supplementary 1,
wherein the processor is configured to classify a plurality of document elements extracted from the document data for each product characteristic, and select, based on a classification result, the document elements to be included in the prompt sentence, thereby controlling an amount of information of the input data to the generative information processing model.

### Supplementary 3

The system according to supplementary 1,
wherein the processor is configured to sequentially update the prompt sentence by using additional inquiry information acquired from the information processing terminal and the document information corresponding to the target product, and repeatedly execute generation processing of the answer information by the generative information processing model, thereby providing product information in a dialog format.

### Example 2

### Supplementary 1

A system comprising a processor,
wherein the processor is configured to
receive, from an information terminal operated by a user, request data including product identification information and a natural language inquiry associated with the product identification information, and analyze the request data,
query, on the basis of the product identification information, at least one document storage in an information storage device to search related document information including handling information and inquiry response information, and extract one or more document segments related to the natural language inquiry from the related document information,
generate a prompt sentence for input to a generative AI model on the basis of the natural language inquiry and the extracted one or more document segments, and cause the generative AI model to generate an answer text in a natural language by performing natural language processing using the prompt sentence, and
construct response data including the generated answer text, and transmit the response data to the information terminal so that the user is presented with the generated answer text in at least one of a text format and a speech-synthesis data format.

### Supplementary 2

The system according to supplementary 1,
wherein the processor is configured to
select, when generating the prompt sentence, the one or more document segments from the related document information according to a degree of relevance to the natural language inquiry, and summarize or truncate the selected one or more document segments such that the prompt sentence fits within a token capacity processable by the generative AI model.

### Supplementary 3

The system according to supplementary 1,
wherein the processor is configured to
output the generated answer text as display data on the information terminal, and, in response to an instruction from the user, supply the generated answer text to a speech synthesis processing unit and convert the generated answer text into an audio signal format to be presented to the user.

### Application Example 2

### Supplementary 1

A system comprising a processor,
wherein the processor is configured to
receive, from an information terminal operated by a user, product identification information input by the user or a product image acquired by the information terminal, and extract product identification information for specifying a target product based on the product identification information and the product image,
search a storage device that stores product-related document information based on the extracted product identification information, and generate document context by extracting, from document information including handling information and question-and-answer information corresponding to the target product, a document portion related to a question content of the user,
construct a prompt sentence for input to a generative AI model based on the document context and the question content of the user, the prompt sentence including at least target product information, the document context, and constraint conditions regarding an expression style of an answer, and thereby instruct the generative AI model to execute answer generation processing, and
obtain a natural language response sentence output from the generative AI model based on the prompt sentence, convert the response sentence into an information format capable of being provided to the user, and transmit the converted response sentence to the information terminal.

### Supplementary 2

The system according to supplementary 1,
wherein the processor is configured to
analyze at least one of voice information, image information, and character information acquired from the user to estimate an emotional state of the user, and change instruction content regarding a detail level, politeness, and information presentation order of the answer included in the prompt sentence in accordance with the emotional state, thereby adjusting content and expression style of the response sentence generated by the generative AI model.

### Supplementary 3

The system according to supplementary 1,
wherein the processor is configured to
calculate a reliability index for the response sentence generated by the generative AI model based on consistency between the response sentence and the document context and a degree of match between the response sentence and attribute information relating to the target product, output the response sentence and the document context to an operation terminal to permit human confirmation or correction when it is determined that the reliability index is less than a predetermined threshold, adopt a response sentence after the confirmation or correction as an answer to be provided to the user, and store the response sentence in the storage device as question-and-answer information associated with the target product.

What is claimed is:

1. A system comprising:
circuitry configured to:
receive, via a communication interface coupled to a packet-switched network, image data from a terminal device, and decode the image data into a normalized image tensor using image processing software;
apply a convolutional neural network to the normalized image tensor to locate text regions and execute optical character recognition on the located text regions to extract character information including candidate identifier strings and confidence scores, and apply a pattern recognition model to the normalized image tensor to extract pattern information including predicted product categories and logo identifiers;
normalize the candidate identifier strings by removing spaces, converting to canonical form, and computing a composite score for each candidate identifier using a weighted combination of the character information and the pattern information, and generate identification information and feature information of a product shown in the image data;
query an information storage device using a query language to retrieve document information associated with a target product identified by the identification information, extract from the document information one or more document segments relevant to a natural language inquiry received from the terminal device, and select and truncate the document segments such that a prompt sentence fits within a token capacity processable by a generative neural network model;
generate the prompt sentence by constructing a prompt including the selected document segments and the natural language inquiry, transmit the prompt sentence to the generative neural network model, and receive answer text generated by the generative neural network model in response to the prompt sentence;
perform content verification processing on the answer text to evaluate a reliability score, and when the reliability score is below a predetermined threshold, transmit the prompt sentence and the answer text to a human response support apparatus and receive supplementary information from the human response support apparatus; and
generate response data by applying formatting processing to the answer text and any supplementary information, and transmit the response data to the terminal device via the communication interface as text data or as audio data generated using speech synthesis software.

2. The system according to claim 1, wherein the circuitry is configured to estimate an emotional state of the user based on at least one of audio data, image data, and text data acquired from the terminal device, and adjust a description style of the prompt sentence and an expression style of the response data in accordance with the emotional state.

3. The system according to claim 2, wherein the circuitry is configured to classify the emotional state into a plurality of emotion categories including at least frustration and confusion, and select a response template variant from among a plurality of predefined response templates based on the classified emotion category.

4. The system according to claim 3, wherein the circuitry is configured to receive additional inquiry information from the terminal device following transmission of initial response data, sequentially update the prompt sentence by appending the additional inquiry information and prior answer text to construct an updated prompt, and transmit the updated prompt to the generative neural network model to generate a subsequent answer text.

5. The system according to claim 4, wherein the circuitry is configured to classify a plurality of document elements extracted from the document information by product characteristic, and select document elements to be included in the prompt sentence based on the classification result and a relevance score computed between each document element and the natural language inquiry.

6. The system according to claim 1, wherein the circuitry is configured to apply string normalization including removal of spaces and hyphens and mapping of known variant strings to canonical codes to the character information, and compute the composite score for each candidate identifier as a weighted combination of OCR confidence scores and pattern recognition probabilities.

7. The system according to claim 6, wherein the circuitry is configured to compute a feature vector from the pattern information including a predicted product category probability distribution and a logo identifier confidence score, and apply a matching function between the feature vector and a product database to select the target product when the composite score exceeds a matching threshold.

8. The system according to claim 7, wherein the circuitry is configured to normalize and integrate the identification information and the feature information into a unified product identifier, and store the unified product identifier in association with session metadata indexed by a user identifier and a timestamp.

9. The system according to claim 8, wherein the circuitry is configured to retrieve document information by performing a matching process between the unified product identifier and product information stored in the information storage device, and return a ranked list of document entries ordered by matching score for subsequent document segment extraction.

10. The system according to claim 1, wherein the circuitry is configured to search, based on the identification information and the feature information, an information storage device storing document data, identify document information corresponding to the target product, classify a plurality of document elements extracted from the document information for each product characteristic, and select document elements based on a classification result.

11. The system according to claim 10, wherein the circuitry is configured to construct the prompt sentence based on the identified document information, the selected document elements, and the natural language inquiry, and supply input data including the prompt sentence to the generative neural network model to generate answer information in a natural language form.

12. The system according to claim 11, wherein the circuitry is configured to receive request data from the terminal device including product identification information and the natural language inquiry associated with the product identification information, query at least one document storage in the information storage device based on the product identification information, and retrieve related document information including handling information and inquiry response information.

13. The system according to claim 12, wherein the circuitry is configured to extract from the related document information one or more document segments relevant to the natural language inquiry, and select and summarize or truncate the one or more document segments such that the prompt sentence fits within a token capacity processable by the generative neural network model.

14. The system according to claim 1, wherein the circuitry is configured to apply preprocessing operations including grayscale conversion, noise reduction, contrast enhancement, and region-of-interest cropping to the image data prior to executing the optical character recognition and pattern recognition, to generate the normalized image tensor with pixel values and dimensions adjusted to match expected input specifications of the convolutional neural network.

15. The system according to claim 14, wherein the circuitry is configured to apply forward propagation through the convolutional neural network on a plurality of candidate text region crops in parallel, and aggregate character recognition outputs across the plurality of crops to generate a unified character information set with ranked confidence scores.

16. The system according to claim 1, wherein the circuitry is configured to convert the response data into audio data using speech synthesis software when an audio output preference is indicated by the terminal device, and transmit the audio data to the terminal device via the communication interface.

17. The system according to claim 16, wherein the circuitry is configured to reflect supplementary information or correction information received from the human response support apparatus in the response data by appending or replacing sections of the answer text with content from the human response support apparatus prior to transmitting the response data to the terminal device.

18. A system comprising:
circuitry configured to:
receive, via a communication interface coupled to a packet-switched network, image data from a terminal device, and decode the image data into a normalized image tensor;
apply a convolutional neural network to the normalized image tensor to extract character information from text regions using optical character recognition and pattern information including product category probabilities and logo identifiers, and compute a composite score for candidate identifiers using a weighted combination of the character information and the pattern information to generate identification information and feature information of a product;
query an information storage device to retrieve document information associated with a target product identified by the identification information, extract document segments relevant to a natural language inquiry, select and truncate the document segments to fit within a token capacity of a generative neural network model, and construct a prompt sentence incorporating the selected document segments and the natural language inquiry;
transmit the prompt sentence to the generative neural network model and receive answer text, and perform content verification processing on the answer text to evaluate a reliability score, and when the reliability score is below a threshold, transmit the prompt sentence and answer text to a human response support apparatus and incorporate supplementary information from the human response support apparatus into response data; and
estimate an emotional state of the user from at least one of audio data, image data, and text data from the terminal device, adjust a description style of the prompt sentence and an expression style of the response data based on the emotional state, and transmit the response data to the terminal device via the communication interface as text data or audio data generated by speech synthesis software.

19. The system according to claim 18, wherein the circuitry is configured to receive additional inquiry information from the terminal device, sequentially update the prompt sentence by appending the additional inquiry information and prior answer text to construct an updated prompt, and transmit the updated prompt to the generative neural network model to generate a subsequent answer text.

20. A method comprising:
receiving, via a communication interface coupled to a packet-switched network, image data from a terminal device, and decoding the image data into a normalized image tensor using image processing software;
applying a convolutional neural network to the normalized image tensor to locate text regions and executing optical character recognition on the located text regions to extract character information including candidate identifier strings and confidence scores, and applying a pattern recognition model to the normalized image tensor to extract pattern information including predicted product categories and logo identifiers;
normalizing the candidate identifier strings and computing a composite score for each candidate identifier using a weighted combination of the character information and the pattern information to generate identification information and feature information of a product;
querying an information storage device using a query language to retrieve document information associated with a target product identified by the identification information, extracting from the document information one or more document segments relevant to a natural language inquiry received from the terminal device, and selecting and truncating the document segments to fit within a token capacity of a generative neural network model;
generating a prompt sentence incorporating the selected document segments and the natural language inquiry, transmitting the prompt sentence to the generative neural network model, and receiving answer text generated by the generative neural network model;
performing content verification processing on the answer text to evaluate a reliability score, and when the reliability score is below a predetermined threshold, transmitting the prompt sentence and the answer text to a human response support apparatus and receiving supplementary information; and
generating response data by applying formatting processing to the answer text and any supplementary information, and transmitting the response data to the terminal device via the communication interface.
